(19) United States
(12) Patent Application Publication
(10) Pub. No.: US 2002/0149791 A1
(43) Pub. Date: Oct. 17, 2002

(54) Image forming system, image forming apparatus, administrative apparatus, program rewriting method and information storage medium

(76) Inventors: Kenichi Ozawa, Tokyo (JP); Fusako Akimoto, Tokyo (JP); Hiroyuki Arai, Tokyo (JP); Toshiyuki Maeshima, Tokyo (JP)

Correspondence Address: CANTOR COLBURN, LLP, 55 GRIFFIN ROAD SOUTH, BLOOMFIELD, CT, 06002

(21) Appl. No.: 10/119,514

(22) Filed: Apr. 9, 2002

(30) Foreign Application Priority Data
Apr. 11, 2001 (JP) 112965/2001

(51) Int. Cl. B41B 1/00; G06F 15/00

(52) U.S. Cl. 358/1.16

(57) ABSTRACT

An image forming system, including: an image forming machine, provided with a rewritable storage for storing a first program, for operating based on the first program so as to conduct image forming on a recording medium; the file administrative system, provided with an administrative storage for storing the second program which is an upgraded version of the first program; and a network for connecting the image forming machine with the file administrative system. The image forming machine includes: a setting controller for setting a first area, where contents of the storage is rewritable, and a second area where contents of the storage is not rewritable; an accessing controller for accessing a file administrative system with a program in the second area to obtain a second program; and rewriting controller for rewriting the first program stored in the first area to the second program.

### BACKGROUND OF THE INVENTION

The present invention relates to an image forming system, an image forming apparatus, an administrative apparatus, a program rewriting method and an information recording medium.

Heretofore, an image forming apparatus has been provided with a rewritable storage section storing a program, and has formed an image on a recording medium by operating based on the program mentioned above. When upgrading in terms of version or debugging for the program of the image forming apparatus, or further, when grasping the state of troubles for the image forming apparatus, a service engineer has been requested to visit the location where the image forming apparatus is installed, to replace ROM, or to connect a memory card and a personal computer to the image forming apparatus for rewriting to the program upgraded in terms of version or debugged (rewritten program).

For the background stated above, there has been tried recently the establishment of a system using a network for upgrading an image forming apparatus in terms of version and for grasping the state of troubles of the image forming apparatus.

Namely, there is established a remote control system (hereinafter referred to as an image forming system) which conducts remote control for the administrative apparatus equipped with an administrative function of the image forming apparatus and for the optional number of image forming apparatuses on the user side connected to the aforesaid administrative apparatus through the network.

Owing to this image forming system, it is possible to rewrite a program automatically for the program for operating an image forming apparatus, when version upgrading is needed. Incidentally, as a network, RS-232C cable is used to be connected, for example, or telephone lines are used to be connected.

Incidentally, in the image forming system stated above, whether the rewriting of the program is needed or not has been decided by a service engineer who has decided by observing the version of the program in the image forming apparatus directly, and rewriting of the program was carried out only when the rewriting was judged to be necessary. In addition, rewriting of the program has also been conducted by the service engineer.

Further, rewriting of a program needs to be conducted while an image forming apparatus is suspended, and therefore, it has been necessary to avoid interruption of the customer's use when rewriting the program.

In addition, if abnormality such as breaking of wire takes place when transferring data from the administrative apparatus side to an image forming apparatus for rewriting program in an image forming system, it does not happen that all data of rewriting program are transferred to the image forming apparatus, instead, only a part of them is transferred.

This means that, in the image forming apparatus, an imperfect control program exists in an inner storage means such as, for example, ROM, resulting in system down and inability of restoration of the image forming apparatus.

In the past, when the situation of this kind takes place, an engineer or a service engineer has been requested to visit the site where the image forming apparatus is installed to do restoration operations by starting again from another ROM. Accordingly, the service engineer had to visit the site when abnormal termination takes place in the course of rewriting of the program.

Further, in the case of an occasion of rewriting (updating) operation, when an operator rewrites directly for the apparatus as in the past, confirmation of version after rewriting and operation confirmation can be carried out by confirming the apparatus directly, and operation termination has been notified directly to a user when the operation is terminated. However, when conducting rewriting operations from the remote location by utilizing public lines in the image forming system, this rewriting operations are conducted, in many cases, at night when the user is not using the apparatus. In this case, when reporting to the user about the notification of termination of operations, it has been necessary to notify later.

Furthermore, when rewriting operations are terminated, it has been necessary, after the termination of the operations, that an operator notifies a user of the termination or the user confirms version by itself.

### SUMMARY OF THE INVENTION

The invention has been achieved in view of the aforesaid background, and its first object is to provide an image forming system, an image forming apparatus, an administrative apparatus, a program rewriting method and an information recording medium, wherein an service engineer neither needs to judge by observing directly the version of a program in an image forming apparatus when conducting rewriting, nor needs to judge the timing for rewriting the program of the image forming apparatus which is out of operation.

The second object of the invention is to provide an image forming system, an image forming apparatus, a program rewriting method and an information recording medium, wherein a service engineer does not need to visit a site even when troubles are caused.

The third object of the invention is to provide an image forming system and an image forming apparatus, wherein an operator does not need to contact a user for notifying about completion of rewriting operations.

The invention for attaining the first object has an image forming apparatus that is provided with a rewritable storage means storing the first program, and operates based on the first program to conduct image forming on a recording medium, a file administrative system that is provided with an administrative storage means storing the second program that is obtained by upgrading the first program in terms of version, and a network which connects the image forming apparatus with the file administrative system, and the image forming apparatus is characterized in that the image forming apparatus obtains the second program by accessing the file administrative system, and has a decision means that decides the timing for rewriting the first program to the second program, and a control means that controls implementation of rewriting based on the results of the decision by the decision means.

The invention has an image forming apparatus that is provided with a rewritable storage means storing the first program, and operates based on the first program to conduct image forming on a recording medium, a file administrative system that is provided with an administrative storage means storing the second program that is obtained by upgrading the first program in terms of version, and a network which connects the image forming apparatus with the file administrative system, wherein the administrative apparatus of the file administrative system has a setting means to set the rewriting timing, and the image forming apparatus obtains the second program by accessing the program based on instruction of downloading transmitted from the program administrative system, and a decision means that decides whether the first program can be rewritten to the second program or not and a control means that controls implementation of rewriting based on the results of the decision by the decision means are included.

The invention has an image forming apparatus that is provided with a rewritable first storage means storing the first program, and operates based on the first program to conduct image forming on a recording medium, a program administrative system having an administrative storage means storing the second program that is obtained by upgrading the first program in terms of version, a general network which connects the user network with the program administrative system, a sub-host provided with a second storage means that obtains the second program stored in the administrative storage means by accessing the program administrative system through the general network and stores the second program, and a user network that connects the image forming apparatus with the sub-host, wherein the image forming apparatus obtains the second program stored in the second storage means through the user net work and a decision means that decides the timing for rewriting the first program to the second program and a control means that controls implementation of rewriting based on the results of the decision are included.

The invention is an image forming apparatus that is provided with a rewritable storage means storing the first program, wherein a decision means that decides the timing for rewriting the first program to the second program, by acquiring the new second program through the network to be connected, a first connection starting means that starts connection to the network for acquisition in the course of warm-up after turning on power supply for the image forming apparatus, and a control means that controls implementation of rewriting by starting connection by the first connection starting means based on the results of the decision by the decision means are included.

The invention is an image forming apparatus that is provided with a rewritable storage means storing the first program, wherein a decision means that decides the timing for rewriting the first program to the second program, by acquiring the new second program through the network to be connected, a second connection starting means that starts connection to the network for acquisition in a predetermined specific time zone when the image forming apparatus is not in use, and a control means that controls implementation of rewriting by starting connection by the second connection starting means based on the results of the decision by the decision means are included.

The invention is an administrative apparatus that is connected with an image forming apparatus that forms an image on a recording medium through the network and controls the image forming apparatus for rewriting the first program of the image forming apparatus to the second program, wherein a transmission means to transmit the second program to the image forming apparatus, a setting means for setting the timing for rewriting, and a control means which conducts instruction for downloading for the image forming apparatus from the transmission means at the timing set by the setting means and controls so that the image forming apparatus is urged to obtain the second program.

The invention is a program rewriting method to rewrite the first program to the new second program with an administrative apparatus which is made to be capable of communicating with an image forming apparatus forming an image on a recording medium based on the first program through the network, wherein the image forming apparatus accesses the administrative apparatus in the course of warm-up after turning on power supply for the image forming apparatus to obtain the second program and a step to rewrite the first program to the second program is included.

The invention is a program rewriting method for rewriting the first program to the new second program by the administrative apparatus which is made to be capable of communicating with the image forming apparatus for conducting image forming on a recording medium based on the first program through the network, wherein the image forming apparatus accesses the administrative apparatus during the specific time zone when the image forming apparatus set in advance is not used yet to obtain the second program, and a step to rewrite the first program to the second program is included.

The invention is a program rewriting method for rewriting the first program to the new second program by the administrative apparatus which is made to be capable of communicating with the image forming apparatus for conducting image forming on a recording medium based on the first program through the network, wherein there are included a step for setting the timing for rewriting conducted on the administrative apparatus side, and a step for conducting instruction for downloading for the image forming apparatus from the administrative apparatus at the timing set and urges the image forming apparatus to obtain the second program.

The invention is one where there is recorded a program to rewrite the first program to the new second program by the administrative apparatus which is made to be capable of communicating with the image forming apparatus for conducting image forming on a recording medium based on the first program through the network, wherein there is included information of processing that the image forming apparatus accesses the administrative apparatus in the course of warm-up after turning on power supply for the image forming apparatus to obtain the second program and the first program is rewritten to the second program.

The invention is one where there is recorded a program to rewrite the first program to the new second program by the administrative apparatus which is made to be capable of communicating with the image forming apparatus for conducting image forming on a recording medium based on the first program through the network, wherein there is included information of processing that the image forming apparatus accesses the administrative apparatus during the specific time zone when the image forming apparatus set in advance is not used yet to obtain the second program, and the first program is rewritten to the second program.

The invention is one where there is recorded a program to rewrite the first program to the new second program by the administrative apparatus which is made to be capable of communicating with the image forming apparatus for conducting image forming on a recording medium based on the first program through the network, wherein there are included information of conducting processing for setting the timing for rewriting on the administrative apparatus side and information of conducting instruction for downloading for the image forming apparatus from the administrative apparatus at the timing set and of urging the image forming apparatus to obtain the second program.

The invention for attaining the second object has an image forming apparatus that is provided with a rewritable storage means storing the first program, and operates based on the first program to conduct image forming on a recording medium, a file administrative system that is provided with an administrative storage means storing the second program that is obtained by upgrading the first program in terms of version, and a network which connects the image forming apparatus with the file administrative system, and the image forming apparatus is characterized in that a setting means that sets in advance the first area that can rewrite contents of the storage in the storage means and the second area that cannot rewrite, and a rewriting means that accesses the file administrative system with program of the second area to obtain the second program and rewrites the first program stored in the first area to the second program are included.

The invention has an image forming apparatus that is provided with a rewritable first storage means storing the first program and operates based on the first program to conduct image forming on a recording medium, a file administrative system provided with an administrative storage means that stores the second program obtained by upgrading the first program in terms of version, and a network which connects the image forming apparatus with the file administrative system, and the image forming apparatus is characterized to include a second storage means that stores an instruction for jump to the first storage means and a control means that sets and controls so that startup may be started by the second storage means when the image forming apparatus is operating.

The invention is an image forming apparatus that is provided with a rewritable first storage means storing the first program and operates based on the first program to conduct image forming on a recording medium which is characterized to include a setting means that establishes in advance the first area which is rewritable and the second area which is not rewritable, concerning the contents stored in the storage means, and a rewriting means which accesses the network connected by a program of the second area to obtain a new second program, and rewrites the first program stored in the first area to the second program.

The invention is an image forming apparatus that is provided with a rewritable first storage means storing the first program and operates based on the first program to conduct image forming on a recording medium which is characterized to include a second storage means that stores an instruction for jump to the first storage means and a control means that sets and controls so that startup may be started by the second storage means when the image forming apparatus is operating.

The invention is a program rewriting method to rewrite the first program to the new second program with an administrative apparatus which is made to be capable of communicating with an image forming apparatus forming an image on a recording medium based on the first program through the network, which is characterized to include a step to decide whether the first program stored in the first area in the storage means of the image forming apparatus is abnormal or not, and a step to rewrite the first program to the second program based on the minimum program stored in the second area of the storage means when the first program is decided to be abnormal.

The invention is a program rewriting method to rewrite the first program to the new second program with an administrative apparatus which is made to be capable of communicating with an image forming apparatus forming an image on a recording medium based on the first program through the network, which is characterized to include a step wherein startup is started by the second storage mean that stores an instruction for jump to the first storage means storing the first program when the image forming apparatus is operating.

The invention is one where there is recorded a program to rewrite the first program to the new second program by the administrative apparatus which is made to be capable of communicating with the image forming apparatus for conducting image forming on a recording medium based on the first program through the network, wherein information for conducting processing to decide whether the first program stored in the first area of the storage means in the image forming apparatus is abnormal or not, and information for conducting processing to rewrite the first program to the second program based on the minimum program stored in the second area of the storage means when the first program is decided to be abnormal, are included.

The invention is one where there is recorded a program to rewrite the first program to the new second program by the administrative apparatus which is made to be capable of communicating with the image forming apparatus for conducting image forming on a recording medium based on the first program through the network, wherein information for processing with which the startup is started by the second storage mean that stores an instruction for jump to the first storage means storing the first program when the image forming apparatus is operating, is included.

The invention for attaining the third object has an image forming apparatus that is provided with a rewritable storage means storing the first program, and operates based on the first program to conduct image forming on a recording medium, a file administrative system that is provided with an administrative storage means storing the second program that is obtained by upgrading the first program in terms of version, and a network which connects the image forming apparatus with the file administrative system, and the image forming apparatus is characterized to include a rewriting means that obtains the second program through the network and rewrites the first program to the second program and a control means that controls to output a report of completion of rewriting processing when the rewriting processing by the rewriting means is completed.

The invention is an image forming apparatus of a combination type in which an image is formed on a recording medium based on the first program, and the first program can be rewritten to the second program obtained by upgrading the first program in terms of version by an administrative apparatus that is made to be capable of communicating through the network, and each of a facsimile means that forms an image in facsimile procedures, a means that conducts image forming by data from an information processing apparatus and an image forming means that conducts image forming based on image information from a document reading means is used through mode switching, wherein the image forming apparatus obtains the second program through the network and there are included a rewriting means for rewriting the first program to the second program and a control means that controls to output a report of completion of rewriting processing when the rewriting processing by the rewriting means is completed.

### BRIEF DESCRIPTION OF THE DRAWINGS

FIG. 1 is a functional block diagram showing an example of an overall structure of an image forming system of the example relating to the invention.

FIG. 2 is an illustration showing the outline of the image forming system shown in FIG. 1.

FIG. 3 is a functional block diagram showing the structure of an image forming apparatus that constitutes the image forming system shown in FIG. 1.

FIG. 4 is an illustration showing an example of an embodiment of a display screen which is set and operated on the administrative apparatus side or the image forming apparatus side constituting the image forming system shown in FIG. 1.

FIG. 5 is an illustration showing an example of an embodiment of a display screen which is set and operated on the administrative apparatus side or the image forming apparatus side constituting the image forming system shown in FIG. 1.

FIG. 6 is an illustration showing an example of an embodiment of a display screen which is set and operated on the administrative apparatus side or the image forming apparatus side constituting the image forming system shown in FIG. 1.

FIG. 7 is a sequence diagram showing sending and receiving between the image forming apparatus and the administrative apparatus in the image forming system shown in FIG. 1.

FIG. 8 is a sequence diagram showing sending and receiving between the image forming apparatus and the administrative apparatus in the image forming system shown in FIG. 1.

FIG. 9 is a sequence diagram showing sending and receiving between the image forming apparatus and the administrative apparatus in the image forming system shown in FIG. 1.

FIG. 10 is a sequence diagram showing sending and receiving between the image forming apparatus and the administrative apparatus in the image forming system shown in FIG. 1.

FIG. 11 is a functional block diagram showing an example of an overall structure of an image forming system of the other example relating to the invention.

FIG. 12 is a sequence diagram showing sending and receiving between the image forming apparatus and the administrative apparatus in the image forming system shown in FIG. 11.

FIG. 13 is a sequence diagram showing sending and receiving between the image forming apparatus and the administrative apparatus in the image forming system shown in FIG. 11.

FIG. 14 is a sequence diagram showing sending and receiving between the image forming apparatus and the administrative apparatus in the image forming system shown in FIG. 11.

FIG. 15 is a functional block diagram showing an example of the overall structure of the image forming system of another example relating to the invention.

FIG. 16 is a sequence diagram showing sending and receiving between the image forming apparatus and the administrative apparatus in the image forming system shown in FIG. 15.

FIG. 17 is a sequence diagram showing sending and receiving between the image forming apparatus and the administrative apparatus in the image forming system shown in FIG. 15.

FIG. 18 is a sequence diagram showing sending and receiving between the image forming apparatus and the administrative apparatus in the image forming system shown in FIG. 15.

FIG. 19 is an illustration showing an example of the overall structure of the image forming system of another example relating to the invention.

FIG. 20 is an illustration showing a memory map of the image forming apparatus constituting the image forming system shown in FIG. 19.

FIG. 21 is a flow chart showing processing procedures of the image forming apparatus constituting the image forming system shown in FIG. 19.

FIG. 22 is an illustration showing an example of the overall structure of the image forming system of another example relating to the invention.

FIG. 23 is a flow chart showing processing procedures of the image forming apparatus constituting the image forming system shown in FIG. 22.

FIG. 24 is a functional block diagram showing an example of the overall structure of the image forming apparatus constituting the image forming system of another example relating to the invention.

FIG. 25 is a flow chart showing processing procedures of the image forming apparatus shown in FIG. 24.

### DETAILED DESCRIPTION OF THE INVENTION

A preferable example of the invention will be explained concretely as follows, referring to the drawings.

### FIRST EXAMPLE

(Overall Structure of System)

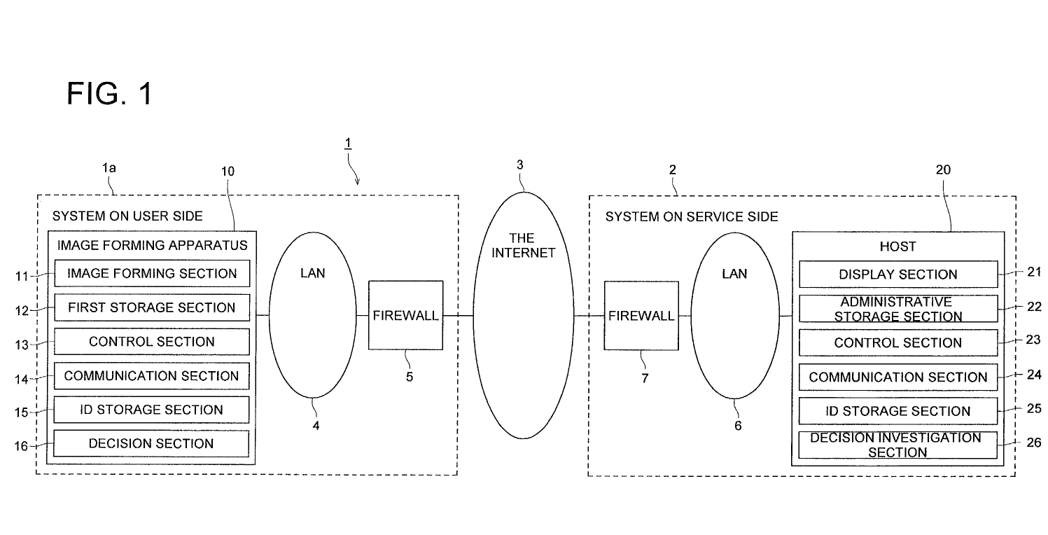

First, overall schematic structure of the image forming system of the invention will be explained as follows, referring to FIG. 1. FIG. 1 is a functional block diagram showing the structure of the image forming system of the example.

The present example is one which is capable when the automatic program rewriting system of the image forming apparatus employing a network is realized.

As shown in FIG. 1, image forming system 1 of the present example is composed of system on user side 1a, system on service side 2 and the internet 3 representing a network connected for sending and receiving information between the system on user side 1a plus the system on service side 2 and image forming apparatus 10.

In the system on user side 1a, the image forming apparatus 10 and local area network 4 (hereinafter referred to as LAN4) representing a network on the user side to which the image forming apparatus 10 is connected are capable of sending and receiving information each other. Though this LAN4 is a user network that is different from the internet 3, it is connected to the internet 3. In order to secure this connection, firewall 5 that regulates passing information is used to block unlawful access from the internet 3.

The image forming apparatus 10 is an apparatus for forming an image on a recording medium, and it is connected to the internet 3 through LAN4 and firewall 5. The image forming apparatus 10 has therein image forming section 11 representing an image forming means that conducts image forming on a transfer sheet serving as a recording medium, first storage section 12 representing a storage means that stores image information, control section 13, communication section 14 representing a communication means which is connected to the network, for example, to conduct communication, ID storage section 15, and decision section 16 representing a decision means for deciding the timing for series of processing including that the image forming apparatus 10 accesses host 20 of the system on service side 2 to obtain a program and rewriting processing is conducted.

In addition, in the case of a compound apparatus wherein an image processing means for performing prescribed processing (magnification changing processing, processing to superpose images and others) on image information which has been received or has been read and storing in first storage section 12, a facsimile communication unit, a printer and a copying machine are combined, a group of many keys (ten-key) performing setting of various modes and inputting, and an operating means that is provided with a start button and conducts operation are provided.

The image forming section 11 is one to form images on a recording medium, and it is possible to use various image forming engines including, for example, engines of an ink jet type or an electrophotographic type. Incidentally, the image forming section 11 can include not only an image forming section main body that conducts image forming on a recording medium but also an image reading section that reads image data on a document, an automatic document conveying section that conveys a document automatically to read the document and a post processing section that conducts post processing (sorting and stapling) on a recording sheet on which an image has been formed. Incidentally, the automatic document conveying section and a post processing unit can be added as an option for the image forming section 11 when a user desires them.

The first storage section 12 is a rewritable storage section where various programs are stored including, for example, a flash memory. As a program stored in the first storage section 12, there are given a program for controlling the image forming section 11, a program for conducting sequence control for the image reading section and the post processing section, for example, an image processing program that processes image information obtained by reading, an image writing program that conducts image writing processing, a program for controlling the communication section 14, and a program to control a display section to display the state and setting for unillustrated image forming apparatus 10 and to control a setting section (operation section) for setting image forming conditions. Since the first storage section 12 is rewritable, programs stored in the first storage section 12 can be rewritten respectively to the rewriting program. This rewriting is one to be performed by image forming apparatus 10 itself based on a prescribed program, and this prescribed program is stored in the first storage section 12.

The control section 13 (control means) is one for controlling each section stated above, and it controls the image forming apparatus 10 based on various programs stored in the first storage section 12. In addition, the control section 13 has a function to administrate and control the state of constituent sections of the compound apparatus, and it includes an image control section for controlling an image forming section, a printer control section, an operation control section and a communication control section.

The communication section 14 (communication means) is one to take charge of communication for sending and receiving of information in LAN4 and for sending and receiving of information for the internet 3 through LAN4 and firewall 5. Incidentally, the communication section 14 may be constituted with a network control unit for conducting calling with a public network such as NTT, and connection control such as called from many and unspecific targets, reverting and disconnection processing, and with a communication modem which demodulates modulation signals transmitted through the public network in the course of receiving and converts them into digital received images, and modulates document image information and converts into modulation signals so that they may be compatible with frequency band of the public network in sending.

The ID storage section 15 is a storage section that stores various pieces of ID information. As ID information stored in the ID storage section 15, there are given various pieces of program information stored in the first storage section 12 (information of a date on which a program was prepared, information of a date on which a program was stored, version information of a program, information of a program type and program history, and information of an image forming apparatus type that specifies a type of image forming apparatus 10), ID information (serial number) of the image forming apparatus for specifying univocally the image forming apparatus 10, information of host 20 in the system on service side 2 that administrates the image forming apparatus 10, and a password for authenticating in communication with host 20.

A serial number for specifying univocally each unit (for example, an automatic document conveying means and a post processing section) which is added as an option to image forming apparatus 10 can naturally be stored.

Incidentally, the structure where copy function only is extracted in image forming apparatus 10 representing a compound apparatus can constitute an image forming apparatus.

An unillustrated operation means of the image forming apparatus 10 is composed of a touch-panel that receives operations and a display means that is made of LCD which displays patterns and characters, both of which are arranged to be superposed, and the operation means has a display-operation section which is operated by pressing a touch-panel at the position displayed on LCD, a single-hand operation key for a single-hand operation dial for implementing single-hand operation transmission and multi-destination delivery, a key button for inputting telephone numbers composed of a ten-key including “0”-“9”, “*” key, and “#” key, a check button, a help button, an application button, a reset button, a stop/clear button, an interruption copy button, and a mode-change key for switching start/copy function, facsimile function and printer function. Due to this, with regard to the operation means, the desired setting can be conducted when the display means displays on the screen described later.

Incidentally, in the development of one image area on the displayed screen on the display-operation section (display-operation means), there is displayed and formed a setting screen for setting the rewriting time including an unused time zone such as weekly timer setting time. In this case, the control section 13 is controlled so that rewriting may be conducted based on the timing established on the setting screen.

LAN4 is an information communication network installed on the user side, and this LAN4 is connected not only to the image forming apparatus 10 but also to other image forming apparatuses and personal computers which transmit image data so that images are formed by the image forming apparatus 10. To this LAN4, there is connected firewall 5 that is connected to the internet 3 and regulates passing information.

In system on service side 2, there are provided host 20 representing an administrative apparatus, local area network 6 (hereinafter referred to also as LAN6) representing a network on the service side to which the host 20 is connected, and firewall 7 which connects the LAN6 with the internet 3 and regulates passing information. In the present example, the system on service side 2 serves also as a program administrating system (file administrating system) that administrates program (second program) including a program obtained by upgrading the main program (first program) stored in the first storage section 12 of the image forming apparatus 10 in terms of version, and a program for bug correction.

The host (administrative apparatus) 20 is an administrative apparatus for administrating the image forming apparatus 10 (and other plural image forming apparatuses), and it is connected to the internet 3 through LAN4 and firewall 5. To be more concrete, the host 20 grasps the state of the image forming apparatus 10 administrated by the host 20, and in the present example, the host 20 grasps the state of the image forming apparatus 10 by administrating the state (version and others) of the program of the image forming apparatus 10. This host 20 has therein display section 21, administrative storage section 22, control section 23, communication section 24, ID storage section 25 and decision investigation section 26 that decides whether the timing for the image forming apparatus 10 is to rewrite or not, and investigates information for setting rewritable timing for the image forming apparatus 10. In addition, there is formed an unillustrated setting section (setting means) that sets the rewritable timing for the image forming apparatus 10.

Display section 21 is one where the state of the image forming apparatus 10 is displayed so that the state of the image forming apparatus 10 may be grasped. Namely, by observing the display, a service engineer on the service side can identify the version of the program and can identify the image forming apparatus 10 employing that program. When the program is updated by the image forming apparatus, the display section 21 is naturally utilized and its setting is carried out from an unillustrated operation section even when setting is conducted, which will be described later.

Administrative storage section 22 (administrative storage means) is a storage section in which programs obtained by upgrading various programs of the image forming apparatus 10 and programs which have been subjected to bug correction, are stored, and its example is a flash memory. Programs stored in the administrative storage section 22 are programs which are obtained by rewriting the various programs mentioned above stored in the first storage, section 12 and are stored on the service side according to circumstances.

Control section 23 (control means) is one that controls each section and host 20. Therefore, when an unused time zone is set by an unillustrated setting section, an instruction of downloading is given also to the image forming apparatus 10 to control it to urge acquisition of rewriting.

Further, communication section 24 (communication means, transmitting means) takes charge of communication for sending and receiving of information in LAN6 and for sending and receiving of information with the internet 3 through LAN6 and firewall 7.

ID storage section 25 is a storage section which stores various pieces of ID information. The ID information stored in the ID storage section 15 includes information of host 20 (serial number for specifying univocally host 20), a password for authentication to be done when performing communication with image forming apparatus 10, a serial number an image forming apparatus administrated by the host 20 and rewriting program information stored in the administrative storage section 22 (information of a date on which a program was prepared, information of a date on which a program was stored, version information of a program, information of a program history, and information of a type of an image forming apparatus that specifies a type of image forming apparatus for rewriting).

LAN6 is an information communication network installed on the service side, and host 20 and other hosts are connected with this LANG. Though this LAN6 is a service network that is different from the internet 3, it is connected to the internet 3. In order to secure this connection, firewall 7 that regulates passing information is used to block unlawful access from the internet 3.

In the image forming system 1 structured in the aforesaid way, procedures for rewriting of various programs stored in the first storage section 12 of the image forming apparatus 10 will be explained as follows. Incidentally, prior to the procedures which will be explained below, rewriting programs are already stored in the administrative storage section 22, and information of the rewriting programs is stored in ID storage section 25 in the system on service side 2.

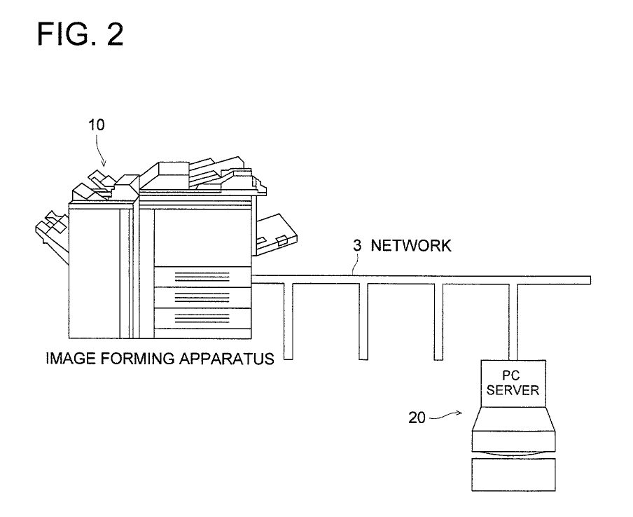

When the rewritable program of the image forming apparatus 10 becomes necessary to be rewritten for upgrading, a service engineer does not visit the location where the image forming apparatus is installed to rewrite manually, differently from the past, instead, the image forming apparatus 10 connects with the network automatically at the timing established in advance as shown in FIG. 2, in the image forming apparatus system 1, and accesses certain host 20 (structured with PC server, as an example) of file administrative system.

The image forming apparatus 10 compares a version of its own program with a version of host 20, and if it decides that the program of itself is older than that of the host 20 in terms of version, the image forming apparatus 10 rewrites automatically to the new version. By doing this, it is possible to use an image forming apparatus with a new version program constantly, without being conscious of a version of the program.

(Function Structure of a Control System on the Image Forming Apparatus Side)

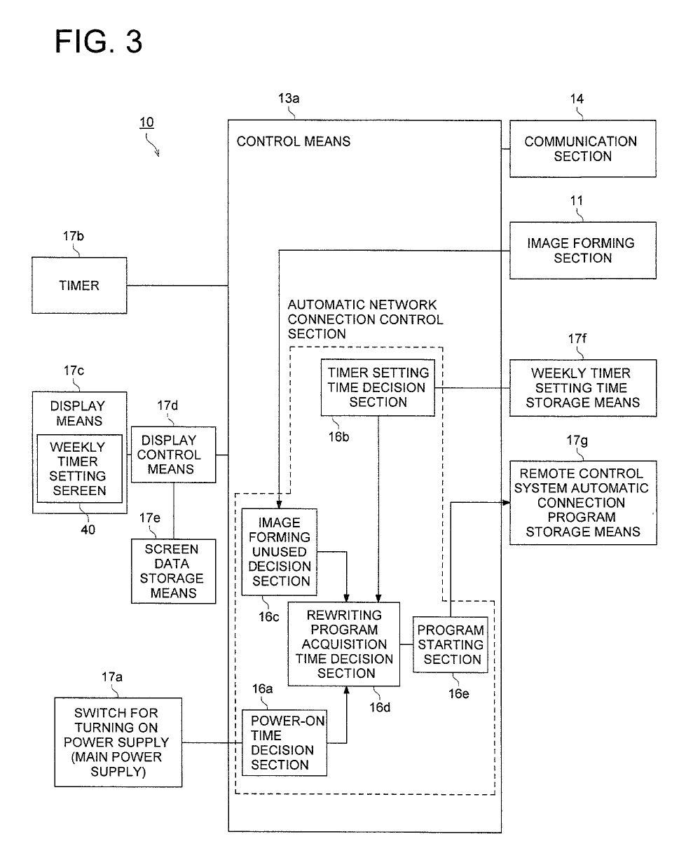

Next, the structure of a control system on the image forming apparatus will be explained as follows, referring to FIG. 3. FIG. 3 is a functional block diagram showing functionally the concept (of processing on the image forming apparatus side) for controlling implementation of the rewriting program in accordance with the occasion wherein an operation period and a suspension period of the image forming apparatus are set by “weekly timer” function and with the condition of turning on power supply, in the image forming system.

Incidentally, each “-means” and each “-section” shown in FIG. 3 may either be realized by combination of various software and hardware or be realized by only hardware or by only software.

In the same way as in the structure stated above, the image forming apparatus 10 includes and is composed of image forming section 11, communication section 14, switch for turning on power supply 17a which starts and terminates power supply to each mechanism inside the image forming apparatus and is called the so-called main power supply, display means 17c for indicating various types of screens (for example, weekly timer setting screen 40 for setting weekly timer) by using, for example, LCD touch-panel, screen data storage means 17e in which the screen data of the screen displayed on the display means 17c, display control means 17d that controls display of the display means based on the screen data storage means 17e, weekly timer setting time storage means (storage area) 17f wherein information such as weekly timer setting time is stored, remote control system automatic connection program storage means (storage area) 17g wherein information such as remote control system (image forming system) automatic program is stored, timer 17b, and control means 13a that controls structural each section in accordance with prescribed control programs.

The control means 13a has the first function that starts a remote control system automatic connection program stored in remote control system automatic connection program storage means 17g, based upon turning on the power, by the switch for turning on power supply 17a to make it possible for the remote control system (image forming system) to operate through communication section 14, and the second function that starts a remote control system automatic connection program stored in remote control system automatic connection program storage means 17g, based upon weekly timer setting time stored in weekly timer setting time storage means 17f, to make it possible for the remote control system (image forming system) to operate through communication section 14.

Namely, the control means 13a includes and is composed of image forming unused decision section 16c that decides, based on the state of use of image forming section 11, whether each mechanism of the image forming apparatus, for example, image forming section 11 is unused or used, power-on time decision section 16a that decides whether the power supply has been turned on by switch for turning on power supply 17a or has been turned off, timer setting time decision section 16b that decides, based on weekly timer setting time information of weekly timer setting time storage means 17f and information of time by timer 17b, whether the present time is weekly timer setting time or not, rewriting program acquisition time decision section 16d that decides, based on judgment information (namely, the state of use representing whether the image forming means is unused or not) in the image forming unused decision section 16c and on judgment information (namely, the state representing whether the power supply has been turned on or not) in the power-on time decision section 16a, whether the time allows to obtain a rewriting program or not, or, decides, based on timer setting time information (the time when the timer has been set or not) of the timer setting time decision section 16b, whether the time allows to obtain the rewriting program or not, and program starting section 16e that obtains remote control system automatic connection program of the remote control system automatic connection program storage means 17g to urge the program to start, based on the results of judgment by the rewriting program acquisition time decision section 16d.

In the control system of the image forming apparatus 10 having the structure mentioned above, switch for turning on power supply 17a is switched first from the state of power-off to the state of power-on, and after the power supply is turned on, power-on time decision section 16a detects that the power supply has been turned on, and outputs the signal to the effect that the power supply has been turned on, for example, the signal of the control of detection of turning on the power, to the rewriting program acquisition time decision section 16d. Further, when the image forming section 11 is unused, the image forming unused decision section 16c outputs the signal to the effect that the image forming section 11 is unused, for example, the image forming unused signal, to the rewriting program acquisition time decision section 16d. Incidentally, when the image forming section 11 is used, the image forming unused decision section 16c controls, and when the image forming unused signal is H-active, it is made to remain at the state of L-level.

On the other hand, when no power supply has been turned on, power-on time decision section 16a does not detect that the power supply has been turned on. Therefore, with respect to the power-on detection control signal, for example, if it is at H-active, for example, it is made to remain at the state of L-level.

Therefore, when the turning on power supply detection control signal from power-on time decision section 16a is at H-level and an image forming unused signal from image forming unused decision section 16c becomes H-level, rewriting program acquisition time decision section 16d urges the start of program starting section 16e. Therefore, when image forming means 11 is in use, program initiation is not started despite that the power supply is turned on.

On the other hand, when the weekly timer is set by weekly timer setting time storage means 17f, timer setting time decision section 16b decides whether the present time is one where the weekly timer is set or not based on time information coming from timer 17b, and if the weekly timer is decided to be set as a result of the judgment, the signal to the effect that the timer is set, for example, the timer setting signal is transmitted to the rewriting program acquisition time decision section 16d. Owing to this, the rewriting program acquisition time decision section 16d urges program starting section 16e to start. Incidentally, when the present time is one for which the timer is not set, timer setting time decision section 16b decides that the time is not the one for which the timer is set. Therefore, if the timer setting signal stated above is H-active, for example, it is left to remain at L-level.

When image forming is unused in the case of turning on the power or when the weekly timer is set as in the foregoing, rewriting program acquisition time decision section 16d supplies to program starting section 16e a signal to the effect to start programs, and thereby, the starting section 16e operates to make remote control system automatic connection program storage means 17g to implement remote control system automatic connection program, to start accessing the aforesaid administrative apparatus through communication section 14.

(Time Setting Layout)

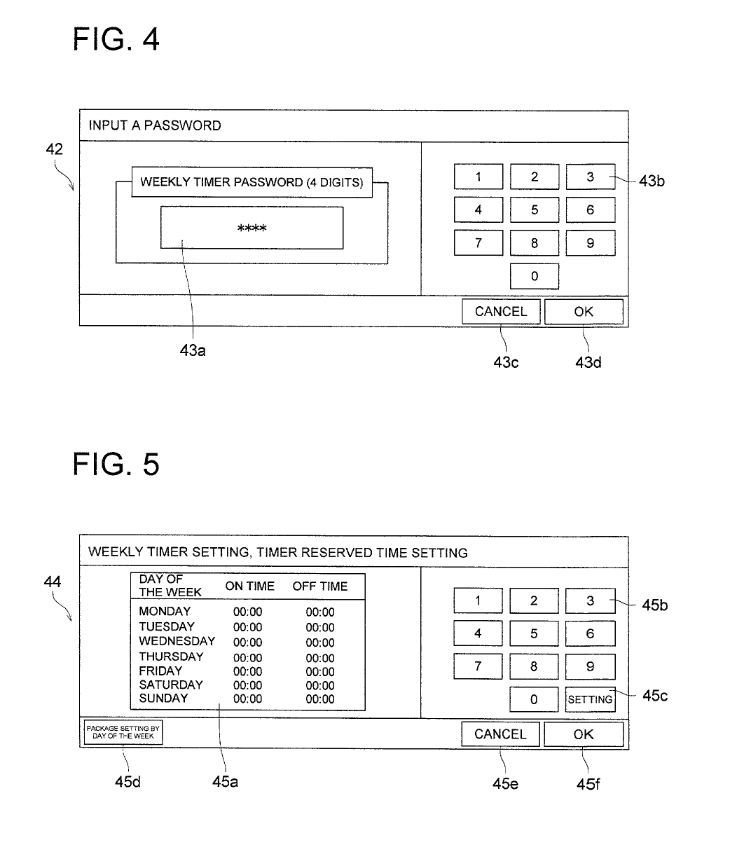

Next, as a method of setting the time and others in the case of accessing a host automatically from an image forming apparatus and thereby conducting download of rewriting program, there will be explained examples of screen development for the occasion to set weekly timer on the image forming apparatus and for the opposite occasion to set weekly timer of the specific image forming apparatus on the administrative apparatus side, referring to FIG. 4-FIG. 6.

First, when setting of the weekly timer is selected from an unillustrated key operator menu screen, there is indicated master key code input screen 42 shown in FIG. 4.

On this master key code input screen 42, there are formed password input blank 43a in which a weekly timer password is to be inputted, numeral keys 43b to be inputted in the password input blank 43a, cancel button 43c for canceling the setting made on the master key code input screen 42, and OK button 43d that makes setting. On the password input screen, it is either possible to input a password (a number of plural figures, for example, a number of four figures) by using the numeral keys 43b on the display screen, or possible to input by using a ten-key which is hardware-like and constitutes an operation means.

Next, in the master key code input screen 42, when the key is decided to be right, there is indicated an unillustrated weekly timer setting menu screen. When timer reservation time setting is selected in this weekly timer setting menu screen, there is indicated timer reservation time setting screen 44 shown in FIG. 5.

On this timer reservation time setting screen 44, there are formed day of the week setting and inputting blank 45a for setting the ON-time for setting the time to turn on the timer for each day of the week or the OFF-time for turning off the timer, numeral key 45b that is used to input a numerical value in each blank of the day of the week setting and inputting blank 45a, setting key 45c for fixing the setting of the inputted numerical value, package setting by day of the week selecting section 45d for moving to the screen for conducting package setting by day of the week, cancel button 45e for canceling the setting made on the timer reservation time setting screen 44, and OK button 45f that conducts setting. On the timer reservation time setting screen 44, it is possible to set ON-time and OFF-time for the power supply for a copying machine with a weekly timer, for each day of the week.

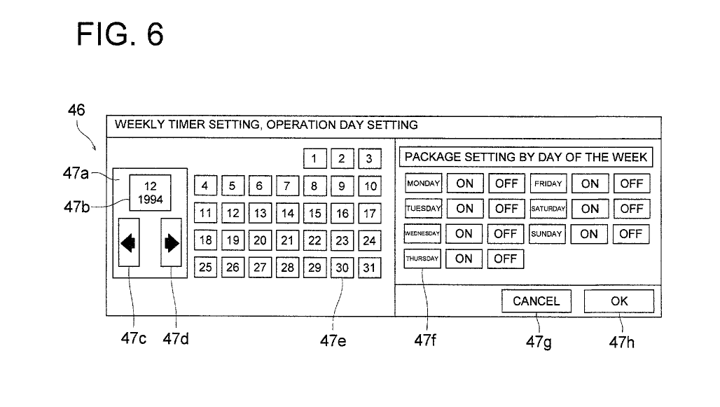

Next, when setting of operation day is selected on the aforesaid unillustrated weekly timer menu screen, operation day setting screen 46 shown in FIG. 6 is displayed.

On this operation day setting screen 46, there are formed operation month setting blank 47a for setting a year and a month for operation, month display blank 47b for displaying the month that is set by the operation month setting blank 47a, selection keys 47c and 47d on the left and right for selecting a month, operation day selecting blank 47e for selecting the operation day, package setting by day of the week blank 47f for conducting package setting by day of the week, cancel button 47g for canceling the setting made on the operation day setting screen 46, and OK button 47h that conducts setting. On this operation day setting screen 46, timer operation (whether or not to turn on the power supply for a copying machine actually when the time of timer comes) is set individually while observing a calendar.

Incidentally, in addition to the setting screen stated above, there are provided a weekly timer setting menu screen, a lunch break off function setting screen and an over time use password setting screen, and these are combined for setting the weekly timer function.

Incidentally, the weekly timer setting menu screen is a menu screen for developing to various items of setting such as weekly timer use setting, timer reservation time setting, operation day setting, lunch break off function setting, and over time use password setting.

Further, on the lunch break off function setting screen, it is possible to set the time to turn off at the lunch break and the time to restart.

In addition, on the over time use password setting screen, it is possible to set a password of four figures, for example, by using the numeral keys.

By setting the unused time zone wherein an image forming apparatus is not used, in the aforesaid manner, it is possible to conduct download of the rewriting program in that unused time zone.

Incidentally, these setting screens may either be provided on the image forming apparatus side or be provided on the setting screen for the image forming system on the administrative apparatus side.

(Processing Procedures)

(When Rewriting in the Course of Warm-Up after Turning on the Power)

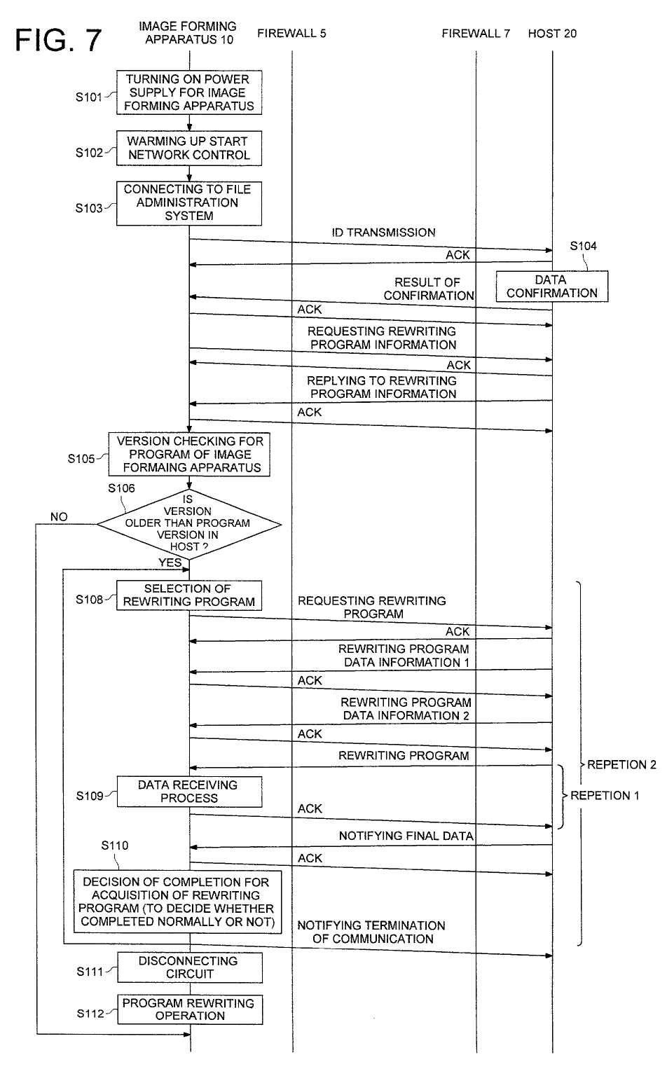

First, rewriting procedures in the case where passing information is strictly regulated by firewall 5 will be explained as follows, referring to FIG. 7 representing a sequence diagram showing the rewriting procedures. In the present example, image forming apparatus 10 itself accesses host 20 to obtain a rewriting program.

First, the power supply is turned on by operating a main power supply button and others on the image forming apparatus 10 (step S 101). Then, the image forming apparatus 10 starts its warm-up. Incidentally, in the present example, rewriting processing is conducted during a period for this warm-up, by utilizing that period. Thus, it is assumed that the entire period for the steps of S 102-S 112 shown below to be processed and completed is a period of warm-up, unless otherwise specified.

After the start of warm-up, processing to conduct connection with a network based on a network connection program is implemented first (S 102). Incidentally, as a communication protocol in the case of conducting connection with the network, the protocol that can go through firewalls 5 and 7, namely FTP, for example, is preferable.

Next, after connected to the network, processing to conduct connection with host 20 of the file administrative system is implemented (S 103). The processing program conducting this processing can constitute, for example, the first connection starting means of the invention.

The image forming apparatus transmits ID information (serial number) and a password of image forming apparatus 10 stored in ID storage section 15 to host 20 through LAN4, firewall 5, the internet 3, firewall 7 and LAN6, by setting a target based on information of host 20 administrating image forming apparatus 10, that information being stored in ID storage section 15. Receiving ID information transmitted from the image forming apparatus 10, the host 20 sends back normal receiving signals (ACK) showing the normal receiving to the image forming apparatus 10. In the image forming apparatus 10, if no ACK is received, the image forming apparatus 10 naturally transmits information again, assuming that transmission was failed (this failure of transmission is applied to each of the following cases of information transmission, and explanation thereof will be omitted).

In the host 20, a judgment is formed for whether ID information received from image forming apparatus 10 agrees with a password or not, or whether it is an image forming apparatus controlled by itself or not, thus, confirmation of data transmitted is decided from information stored in ID storage section 25 (S 104).

Then, data confirmation is completed, and a result of confirmation is sent back to the image forming apparatus 10 as a reply for ID transmission. The image forming apparatus 10, after receiving the result of the confirmation, sends back ACK to host 20 when the result of the confirmation is received normally.

Then, the image forming apparatus 10 transmits to host 20 the rewriting program information request which requests to transmit information of rewriting program stored in administrative storage section 22 of the host 20. The host 20 sends ACK back to the image forming apparatus 10 when receiving normally, after receiving the rewriting program information request. Then, as a reply for this request, the host 20 sends back to the image forming apparatus 10 the rewriting program information stored in the administrative storage section 22 at that time (namely, rewriting program information stored in the ID storage section 25), as a reply of rewriting program information. The image forming apparatus 10, after receiving the reply of rewriting program information, sends back ACK to host 20 when the reply of rewriting program information is received normally.

Then, the image forming apparatus 10 checks the present version of its own control program (first program) stored in first storage section 12 based on version information of ID storage section 15 (S 105).

Next, a judgment is formed from information (version information) of the received rewriting program (second program) and from information (version information) of its program (first program) stored in ID storage section 15, whether its program (first program) is of an old version compared with upgraded version and bug-corrected version for the program (second program) in host 20 or not, namely, whether the rewriting program (second program) needs to be downloaded or not (S 106).

The processing program performing this decision processing can constitute a deciding means for necessity and right and wrong of the invention.

Incidentally, this judgment can also be formed depending on whether the rewriting program is more updated than its own program or not based on program information correlated with its (present time) own program (information of date of preparation, information of date for storage, version information, history information, and information of a type of image forming apparatus) and on rewriting program information correlated with a rewriting program (information of date of preparation, information of date for storage, version information, history information, and information of a type of image forming apparatus).

When the image forming apparatus 10 decides that downloading is necessary, the rewriting program is selected first (the number of the programs that need to be rewritten is not always one because there are plural programs as stated above) (S 108).

After selecting, the image forming apparatus 10 transmits to host 20 a rewriting program request that requests to transmit the selected rewriting program. After receiving the rewriting program request, the host 20 returns ACK to the image forming apparatus 10 when the rewriting program request was received normally by the host 20. Then, the host 20 first sends back rewriting program data information 1 such as an amount of data (data length) of the rewriting program to the image forming apparatus 10 as a response to the rewriting program request, together with rewriting program ID. After receiving the rewriting program data information 1, the image forming apparatus 10 returns ACK to the host 20 when the rewriting program data information 1 was received normally by the image forming apparatus 10. Incidentally, when an amount of data (total amount of one rewriting program) exceeds a receivable size on the image forming apparatus 10, NACK (rejection) information is returned to terminate communication, or to acquire the following rewriting program. After receiving ACK, the host 20 transmits continuously rewriting program data information 2 representing information relating to a transmission method such as transfer block information or compression information to the image forming apparatus 10 as a response to the rewriting program request, together with rewriting program ID. After receiving the rewriting program data information 1, the image forming apparatus 10 returns ACK to the host 20 when the rewriting program data information 1 was received normally by the image forming apparatus 10.

After receiving ACK, the host 20 returns ACK actually to the image forming apparatus 10 as a response to the rewriting program request. In this case, in the transition method shown in the rewriting program data information 2, namely, for replying for each block unit, the image forming apparatus 10 that received ACK conducts data receiving processing for the received data such as accumulating in a memory, combining plural blocks and decompressing of compression. After receiving the rewriting program, the image forming apparatus naturally returns ACK, for each receiving, to the host 20 when the receiving is normal, and the image forming apparatus sends the following block after ACK is received by the host 20.

In this way, the receiving of the rewriting program and data receiving processing are repeated in the image forming apparatus 10 until the data corresponding to an amount of data shown in the rewriting program data information 1 are processed (repetition 1 in the figure) (S 109).

The host 20 replies notification of last data to the image forming apparatus 10 after replying of the last block is completed. After receiving the notification of last data, the image forming apparatus returns ACK to the host 20 when the notification of the last data was received normally by the image forming apparatus.

The image forming apparatus 10 that returned ACK to the host 20 decides completion of acquisition of the rewriting program (S 110).

Namely, the image forming apparatus 10 decides whether it is necessary to download another rewriting program or not, and when downloading is necessary, the sequence returns to the rewriting program selection, and repetition 2 in the figure is repeated until the downloading becomes unnecessary.

On the other hand, if the acquisition of the rewriting program is decided to be completed, the image forming apparatus 10 transmits a notification for the end of communication to the host 20. Receiving this signal, the host 20 disconnects the line to the image forming apparatus 10 (S 111).

The image forming apparatus 10 that transmitted the notification for the end of communication to the host 20 decides, based on rewriting program information and rewriting program data information 1, whether the downloaded (to be transmitted (replied) to meet the request of the source) rewriting program can really be rewritten or not, further, whether the downloaded rewriting program was downloaded accurately or not.

After that, the image forming apparatus 10 judges the condition under which the program rewriting can be conducted. In this judgment, whether the program to be rewritten is used or not for conducting rewriting of the program is judged as a minimum judgment (if it is not used, rewriting can be conducted), and further judgment is formed for rewriting more safely whether a memory to be used as an operation area of CPU representing control section 13 is empty or not, because this memory is used for rewriting (if the memory is empty, rewriting can be conducted). When the rewriting is judged to be possible, the image forming apparatus 10 itself conducts processing to rewrite to the rewriting program based on the prescribed program (S 112).

The processing of this kind is conducted in the course of warm-up as a necessary process.

Incidentally, in judgment in S 106, when rewriting is judged to be unnecessary, these processes (S 108-S 112) are not conducted, and necessary process only is conducted in the course of ordinary warm-up.

For conducting the processing of this kind, the control section 13 (control means) of the image forming apparatus 10, for example, acquires the rewriting program (new main program, second program) to rewrite, when the rewriting is judged to be necessary by decision section 16 (deciding means), and controls so that the image forming apparatus may operate based on the second program.

As stated above, the present example makes it possible to connect with a network automatically, to access a file administrative system and to conduct rewriting automatically when the program rewriting is necessary.

In this case, a user can establish the timing to connect to the network and whether to conduct the automatic rewriting or not. Therefore, it is possible to conduct without using man-hour at the timing when the image forming apparatus is not interrupted, by turning on the power supply for the image forming apparatus in the time zone when the image forming apparatus is not used and by conducting in the course of warm-up, thus, it is possible to use constantly the image forming apparatus under the updated program.

Incidentally, it is also possible to arrange so that it may be possible to be established on an unillustrated screen whether or not the program to conduct a series of rewriting processing mentioned above in the course of warm-up is used.

### SECOND EXAMPLE

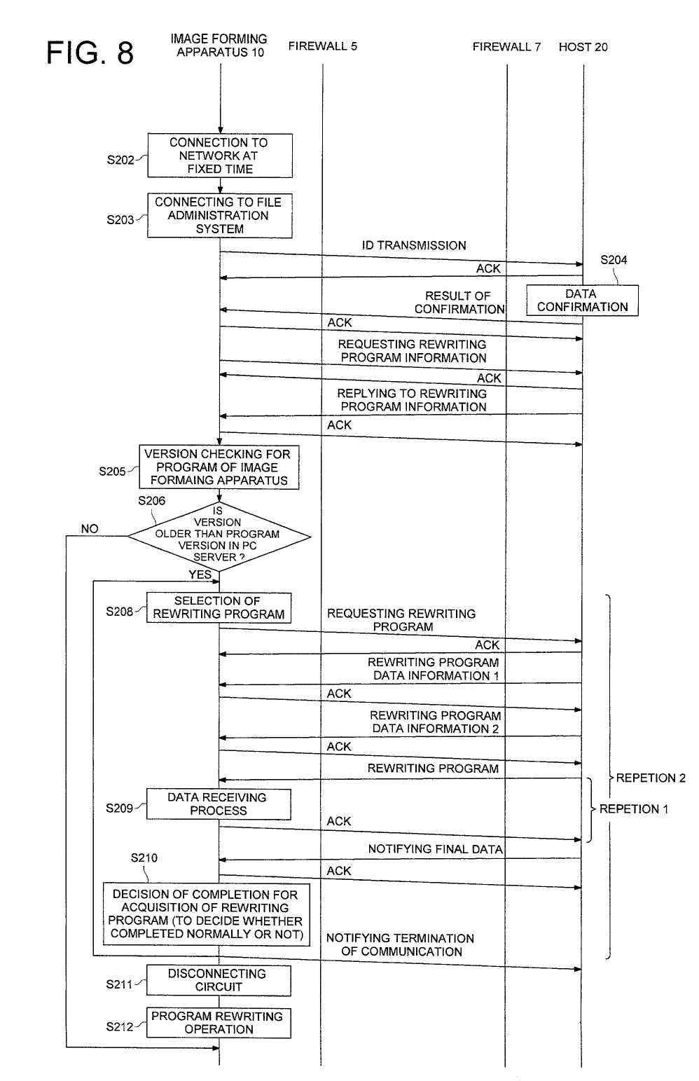

Next, the second example of the invention will be explained as follows, referring to FIG. 8. Incidentally, explanation of the structures in the present example which are substantially the same as those in the first example will be omitted, and different portions only will be explained.

In the first example stated above, there was shown an example wherein rewriting was implemented in the course of warm-up after turning on the power. The present example, however, shows an example wherein a weekly timer function checks whether or not the time when an image forming apparatus is not used is set, and the aforesaid rewriting processing is implemented automatically during the unused time zone. The processing procedures will be explained as follows, referring to FIG. 8.

Incidentally, in the present example, rewriting procedures are those under the condition that passing information is strictly regulated by firewall 5, which is the same as in the first example stated above, and further, image forming apparatus 10 itself accesses host 20 to acquire rewriting programs.

Since the detailed structure of the method to set the weekly timer was already explained in the explanation of the control system in the aforesaid first example, rewriting procedures in the system only will be explained here.

First, image forming apparatus 10 judges whether the time is rewriting program acquiring time or not, and whether the state is an obtainable state or not. In this case, the acquiring time means judgment whether the time arrives at the time and date (the hour) established in advance (unused time zone) or not. Further, the unused time zone is judged whether it is set to be longer than rewriting processing time for conducting a series of processing from downloading in the present example to the finish of rewriting processing (registered generally as a necessary period of time) or not.

Incidentally, judgment whether the state is obtainable state or not means whether communication section 14 is empty or not, because the communication section 14 is used for acquisition (whether another operation is conducted or not) (if it is empty, acquisition is possible) (even if the unused time zone is set, receiving processing such as facsimile is considered to be conducted, in the case of a compound apparatus). Further, for downloading, a memory to be used as an operation area of CPU representing control section 13 is used because the control section 13 is extremely loaded. Therefore, various judgment programs for judging whether the memory is empty or not may be provided. Incidentally, this judgment processing is not always indispensable.

Next, if the time is rewriting program acquiring time and the state is an obtainable state, the image forming apparatus starts to be connected to the network (S 202). Incidentally, as a communication protocol in the case of conducting connection with the network, the protocol that can go through firewalls 5 and 7, namely FTP, for example, is preferable.

Next, after connected to the network in the specific unused time zone, processing to conduct connection with host 20 of the file administrative system is implemented (S 203). Incidentally, the processing program conducting this processing constitutes, for example, the second connection starting means of the invention.

After that, processing steps S 205-S 212 are performed in the same way as S 105-S 112 in the first example stated above. Incidentally, each processing is mostly the same as that in the first example, and detailed explanation therefore will be omitted accordingly.

Incidentally, for conducting the aforesaid processing, when decision section 16 (deciding means) decides that rewriting is necessary, control section 13 (control means) of the image forming apparatus 10 obtains rewriting programs (new main program, second program) in the specific unused time zone to rewrite, and controls so that the image forming apparatus 10 may operate based on the rewriting programs.

As stated above, the present example makes it possible to upgrade in terms of version the control program automatically by using the unused time zone of the image forming apparatus established in advance by a user, while enjoying the same action and effect as in the first example stated above, thus, burdens of a user and an service engineer can be lightened.

Though the rewriting program is downloaded collectively at the specific time in principle, as an assumption, it is also conceivable that a rewriting program is constituted to be divided into plural pieces so that it may be downloaded in a short time, and each program is structured so that it may be downloaded in each desired time. In this case, it is also possible to arrange the structure wherein each program can be downloaded automatically by utilizing selectively the optimum time zone in plural unused time zones. In such a case, materials for judgment may also include circumstances such as a volume of the rewriting program, the communication speed and communication traffic.

### THIRD EXAMPLE

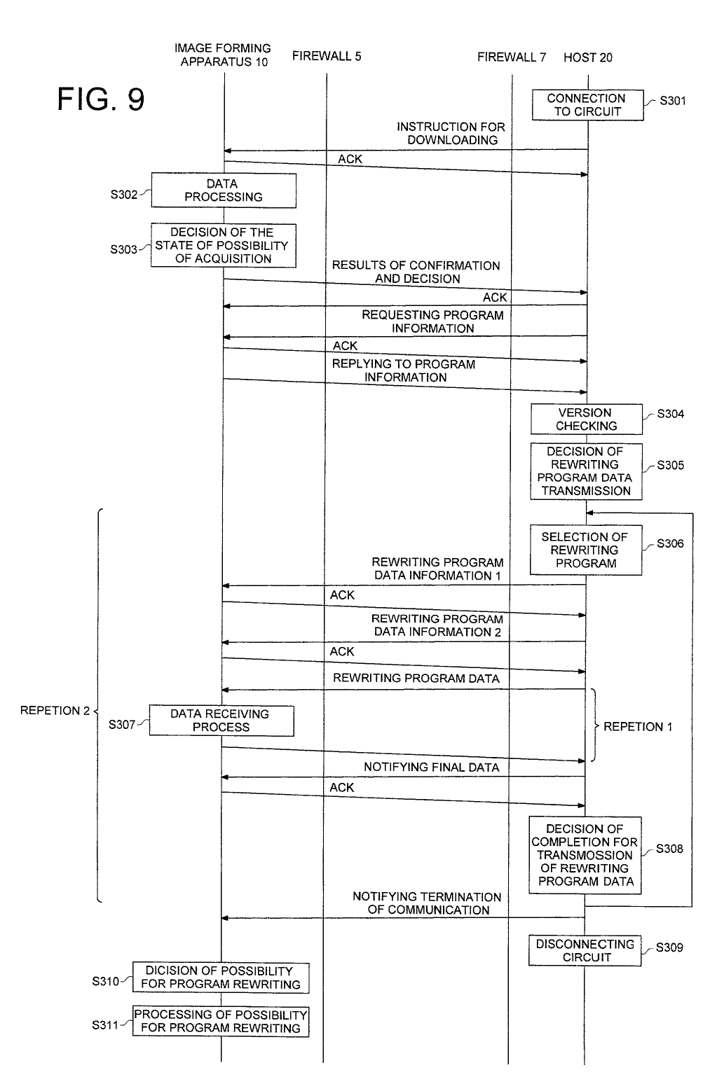

Next, the third example of the invention will be explained as follows, referring to FIG. 9. Incidentally, explanation of the structures in the present example which are substantially the same as those in the first example will be omitted, and different portions only will be explained. FIG. 9 is a sequence diagram show in an example of processing procedures in the image forming system of the present example.

In the first example stated above, the image forming apparatus 10 itself accesses host 20 to acquire rewriting programs. In the present example, however, the host 20 instructs the image forming apparatus 10 to rewrite to the rewriting program.

Incidentally, since the instruction for downloading is transmitted from host 20 to image forming apparatus 10 through the internet 3, it is difficult even for the instruction for downloading to pass through the location where firewall 5 restricts passing information strictly. In the present example, there will be given explanation under the assumption that restriction by firewall 5 for passing information is not strict (an example for the strict restriction will be described later).

Incidentally, procedures identical to those in the first example stated above will be omitted in terms of description below.

First, let it be assumed that information concerning the unused time zone such as weekly timer established in advance by certain specific image forming apparatus 10 is obtained in host 20.

Or, in the case where the image forming apparatus 10 is controlled remotely from the host 20 side, when the time zone that becomes unused time in specific image forming apparatus 10 (naturally possible to set for other plural image forming apparatuses) is established (step to set) by an expected setting means, the host 20 obtains information relating to the time zone from its own administrative storage section and ID storage section.

If there comes the unused time zone when a specific image forming apparatus 10 turns out to be unused under the aforesaid condition, the host 20 connects wires to the image forming apparatus 10 (S 301) and gives an instruction for downloading (download instruction) to the image forming apparatus (image forming apparatus 10 in this case) which is to be subjected to the rewriting program.

In this case, this download instruction is transmitted together with ID information of the image forming apparatus 10 concerned, a password and information of the host 20. After receiving this download instruction, the image forming apparatus 10 returns ACK to the host 20 when the download instruction is received by the host 20 normally.

In this way, the image forming apparatus 10 is urged to obtain the rewriting program. Then, the image forming apparatus 10 judges from the password and information of the host 20 whether the host 20 is one for administrating the image forming apparatus 10 or not, or, judges from ID information of the image forming apparatus 10 whether the apparatus is a right one or not, referring to information stored in ID storage section 15, and confirms data (S 302).

Further, the image forming apparatus 10 judges whether the timing is suitable for obtaining the rewriting program or not (S 303). The processing program conducting this processing can constitute, for example, a means to judge whether the invention is possible or not.

Regarding the suitable timing for obtaining in this case, communication section 14 is judged whether it is open (not doing other operations including receiving facsimile) or not (if it is open, it is obtainable state) because the communication section 14 is used for obtaining, for example, and a memory is judged whether the memory is open or not because the memory to be used as an operation area of CPU representing control section 13 is used, for downloading.

Then, if the state is obtainable for rewriting program, the results of these confirmation and judgment are transmitted to the host 20. After receiving the results of the confirmation and judgment, the host 20 returns ACK to the image forming apparatus 10 when the results of the confirmation and judgment are received by the host 20 normally.

If the apparatus is judged to be right one and the state is judged to be capable of rewriting from the results of the received confirmation and judgment, the host 20 transmits program information request to the image forming apparatus 10 so that information of the program (existing program) stored in the first storage section 12 may be transmitted to the host 20. After receiving this program information request, the image forming apparatus 10 returns ACK to the host 20 when the program information request is received normally by the image forming apparatus 10. Then, the image forming apparatus 10 transmits each type of program information stored in ID storage section 15 as program information to the host 20 as program information reply. After receiving this program information reply, the host 20 returns ACK to the image forming apparatus 10 when the host receives normally the program information reply.

The host 20 checks version based on the program information transmitted from the image forming apparatus 10 (S 304).

The host 20 judges whether it is necessary to transmit rewriting program to the image forming apparatus 10 or not (namely, whether it is necessary for the image forming apparatus 10 to rewrite the program or not), from the program information transmitted from the image forming apparatus 10 and from rewriting program information stored in ID storage section 25 (S 305).

Incidentally, the processing program carrying out these processing can constitute a means to judge whether the invention is necessary or not.

If the image forming apparatus 10 judges that transmission is necessary, the rewriting program is selected first (S 306).

Then, the host 20 transmits rewriting program data information 1 of an amount of data of rewriting program first to the image forming apparatus 10 together with rewriting program ID. After receiving this rewriting program data information 1, the image forming apparatus 10 returns ACK to the host 20 when the rewriting program data information 1 is received normally by the image forming apparatus 10. After receiving ACK, the host 20 transmits rewriting program data information 2 representing information relating to a method of transmitting transmission block information and compression information to the image forming apparatus 10 together with rewriting program ID. After receiving this rewriting program data information 1, the image forming apparatus 10 returns ACK to the host 20 when the rewriting program data information 1 is received normally by the image forming apparatus 10.

After receiving this ACK, the host 20 transmits actually the rewriting program to the image forming apparatus 10. In this case, for the purpose of transmitting in the transmission method shown in rewriting program data information 2, data receiving processing is conducted on the image forming apparatus 10 which received the program. After receiving the rewriting program, the image forming apparatus 10 naturally returns ACK to the host 20 for each receiving, when the receiving is normal, and when the host 20 receives the ACK, the next block is sent.

As stated above, the image forming apparatus 10 repeats the receiving of the rewriting program and data receiving processing until the data whose quantity is equal to the amount shown in the rewriting program data information 1 have been processed (repetition 1 in the figure) (S 307).

Then, when transmission of the last block is completed, the host 20 transmits a last data notification to image forming apparatus 10. After receiving the last data notification, the image forming apparatus returns ACK to the host 20 when its receiving is normal. The host 20 that has received ACK conducts judgment for rewriting program transmission termination (S 308).

When transmission is needed, the sequence returns to rewriting program selection, and repletion 2 in the figure is repeated until the transmission becomes unnecessary. On the other hand, if the transmission of rewriting program is judged to be completed, the host 20 transmits a notification for the end of communication to the image forming apparatus 10. Receiving this signal, the image forming apparatus 10 disconnects the line connecting to the host 20 (S 309).

The image forming apparatus 10 that has received the notification for the end of communication checks whether the obtained rewriting program has been downloaded correctly or not, based on rewriting program information and the rewriting program data information 1 (S 310). After that, the image forming apparatus 10 judges whether the program rewriting is possible or not. Then, when the rewriting is judged to be possible, the image forming apparatus 10 itself performs the processing for rewriting to the rewriting program, based on the prescribed program (S 311).

In the present example, it is possible to conduct downloading and rewriting processing by instructing from the administrative apparatus side while enjoying the same action and effect as in the first and second examples stated above, when information relating to an unused time zone of the image forming apparatus is administrated on the host (administrative apparatus) side, and it is also possible to conduct with only programs used mainly on the administrative side, even when the programs used in the first and second examples are not incorporated in each of plural image forming apparatuses in manufacturing steps and other steps in advance, thus, time for program mounting can be reduced.

### FOURTH EXAMPLE

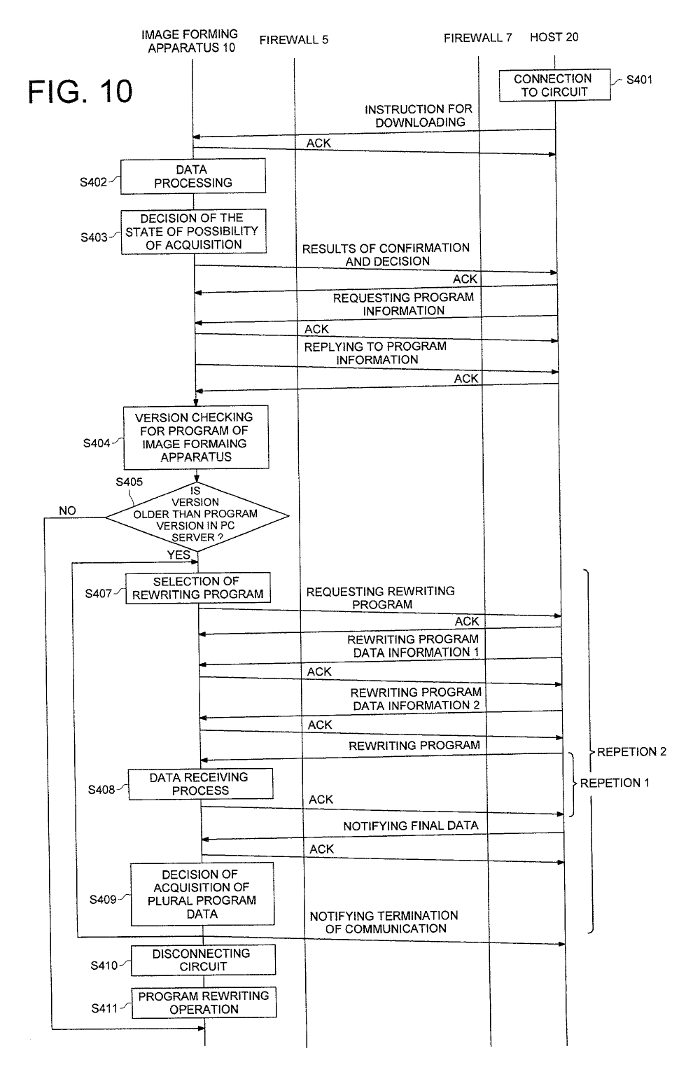

Next, the fourth example of the invention will be explained as follows, referring to FIG. 10. Incidentally, explanation of the structures in the present example which are substantially the same as those in the third example will be omitted, and different portions only will be explained. FIG. 10 is a sequence diagram show in an example of processing procedures in the image forming system of the present example.

Though the third example stated above is of a type of instruction guidance from host 20 wherein information is submitted basically from host 20 and selection of rewriting program to be transmitted is also conducted on the host 20 side, it is also possible to employ the type wherein the steps after instruction of host 20 for downloading (concretely, S 304 and thereafter in FIG. 9) are under the leadership of image forming apparatus 10, as in the first example.

In FIG. 10, steps S 401-S 403 are the same as steps S 301-S 303 in the third example, and steps S 404-S 411 are the same as steps S 105-S 112 in the first example, which means that the fourth example overlaps with the first and third examples, thereby, it will be omitted.

Incidentally, the processing program that conducts processing of S 404 and S 405, for example, can constitute, for example, a means to judge whether necessary or not of the invention.

### FIFTH EXAMPLE

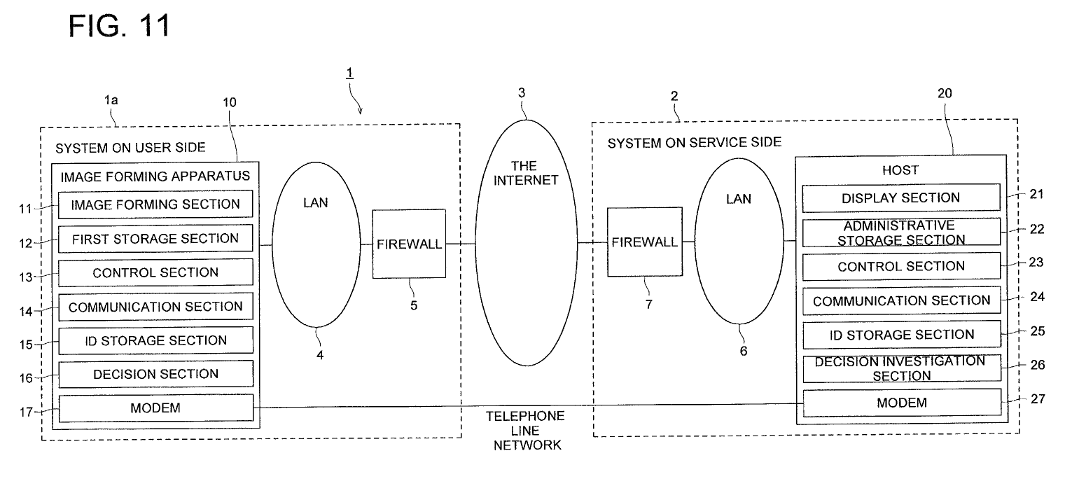

Next, the fifth example of the invention will be explained as follows, referring to FIG. 11. Incidentally, explanation of the structures in the present example which are substantially the same as those in the first example will be omitted, and different portions only will be explained.

Since the download instruction is transmitted from the host 20 to the image forming apparatus 10 through the internet 3 in the third and fourth examples, it is difficult even for such download instruction to pass through a location where restriction by firewall 5 is strict for passing information. This problem can be solved in the structure of the present example.

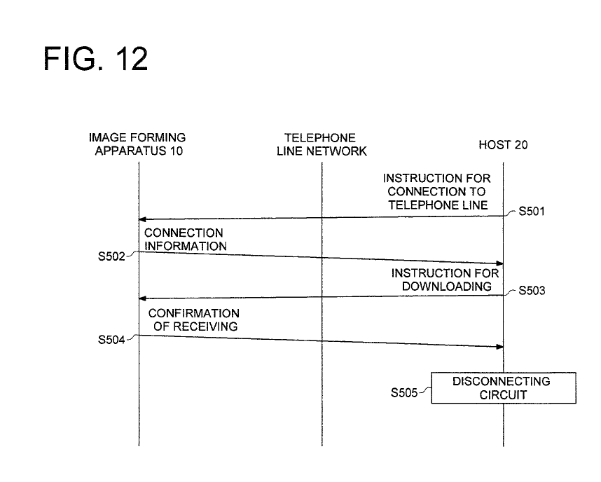

The fifth example will be explained as follows. FIG. 11 is a block diagram showing an overall structure of the image forming system, and FIG. 12 is a sequence diagram showing procedures of download instruction.

Incidentally, FIG. 11 is basically the same as the block diagram in FIG. 1 (the same functions and portions are given the same symbols), and different points only will be explained, and explanation for other points will be omitted because they are the same as those in FIG. 1.

In FIG. 11, modem 17 is provided on the image forming apparatus 10 and modem 27 is provided on the host, which makes FIG. 11 to be different from FIG. 1. These modems 17 and 27 are connected to the telephone line network (network that is different from the internet 3) representing public lines to conduct conversion between digital signals and analog signals. Namely, the image forming apparatus 10 and the host 20 result in the state to be connected on a P to P basis. Incidentally, though it is preferable that these modems 17 and 27 are directly provided respectively on the image forming apparatus 10 and the host 20, it is also possible to provide a modem in each LAN so that the image forming apparatus 10 and the host 20 turn out to be in the state for direct communication.

Next, how to give the download instruction in rewriting procedures in the present example will be explained as follows, referring to FIG. 12 representing the sequence diagram showing procedures for download instruction that is a part of the rewriting procedures.

First, when rewriting programs are stored in administrative storage section 22 and an unused time zone of the specific image forming apparatus 10 comes, the host 20 uses modem 27 to call the image forming apparatus to be subjected to rewriting program (image forming apparatus 10 in this case) through the telephone line network to start communication (make a telephone call) (S 501).

Then, the image forming apparatus 10 that received the call returns connection information to the host 20 for confirmation of the form of communication (S 502). Incidentally, these telephone line connection instruction and connection information correspond to negotiation in communication using a telephone line.

After the negotiation is completed, the host 20 gives an instruction (download instruction) to the image forming apparatus 10 so that it may download (S 503). In this case, the download instruction is transmitted together with ID information of the image forming apparatus 10 to be targeted, a password and information of the host 20. After receiving the download instruction, the image forming apparatus 10 returns confirmation of receipt (ACK in the aforesaid form of communication) to the host 20 if the receipt is normal (S 504). After this is received by the host 20, telephone lines are disconnected (S 505).

Incidentally, since each processing conducted during the aforesaid period is the same as that in the third and fourth examples, detailed explanation will be omitted.

In the present example, telephone lines are used while enjoying the same action and effect as in the example stated above, as stated above, and thereby, a firewall can be avoided.

### SIXTH EXAMPLE

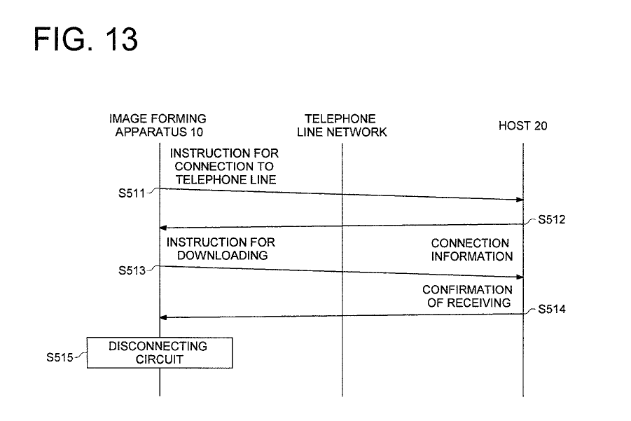

Next, the sixth example of the invention will be explained as follows, referring to FIG. 13. Incidentally, explanation of the structures in the present example which are substantially the same as those in the fifth example will be omitted, and different portions only will be explained.

In the fifth example, there was explained an example wherein telephone lines were used when the download instruction was given from the host side. In the present example, however, there is shown an example wherein telephone lines are used even in the case of accessing from the image forming apparatus side.

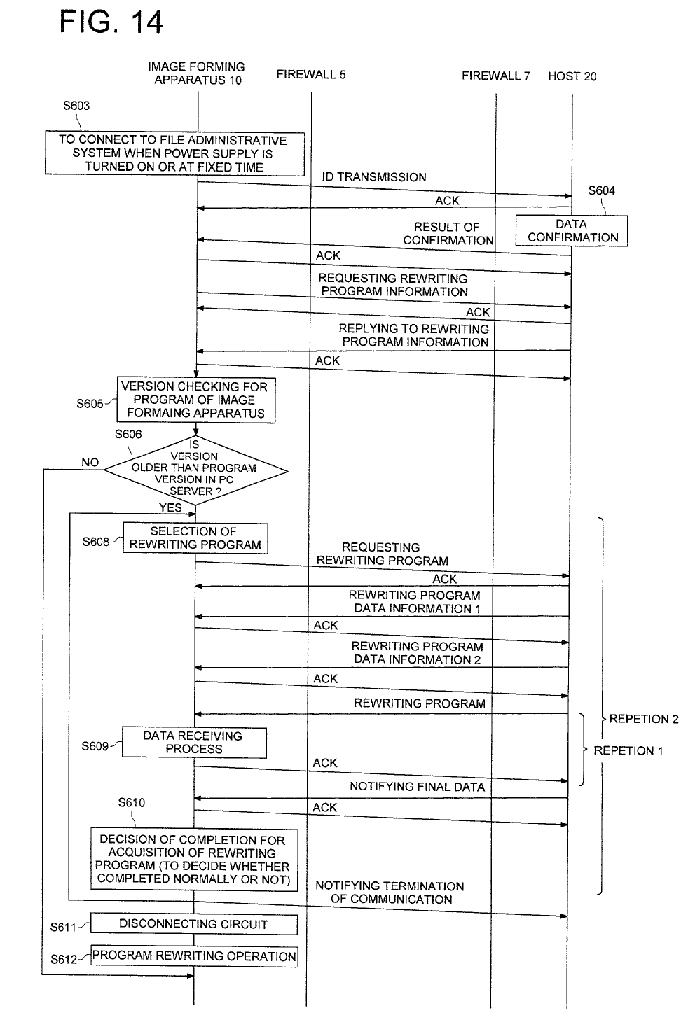

The sixth example will be explained as follows. FIG. 13 is a sequence diagram showing the procedures of download instruction. FIG. 14 is a sequence diagram showing rewriting procedures to be performed after the instruction is received.

First, how to give a download instruction in the rewriting procedures of the present example will be explained, referring to FIG. 13 representing a sequence diagram showing the procedures of the download instruction that is a part of the rewriting procedures.

After the power supply is turned on (or when unused time zone such as weekly timer setting time comes), the image forming apparatus 10 uses modem 17 to call the host 20 through the telephone line network to start communication (make a telephone call) (S 511). Then, the host 20 that received the call returns connection information to the image forming apparatus 10 for confirmation of the form of communication (S 512). Incidentally, these telephone line connection instruction and connection information correspond to negotiation in communication using a telephone line.

After the negotiation is completed, the image forming apparatus 10 gives an instruction (download instruction) to the host 20 so that it may download (S 513). In this case, the download instruction is transmitted together with information such as ID information of the image forming apparatus 10 and a password. After receiving the download instruction, the host 20 returns confirmation of receipt (ACK in the aforesaid example) to the image forming apparatus 10 if the receipt is normal (S 514). After this is received by the image forming apparatus 10, telephone lines are disconnected (S 515).

Thus, the image forming apparatus can start access to the host by using telephone lines.

Rewriting procedures after that or each processing before disconnecting circuit in S 515 will be explained as follows, referring to FIG. 14. Incidentally, in this explanation again, explanation of objects which are the same as those in the first example may be omitted.

As stated above, the download instruction is conducted with telephone lines through modems 17 and 27 even after the power supply is turned on (or in an unused time zone), and is connected to the host 20 (S 603).

Then, the image forming apparatus 10 transmits ID information (serial number) of the image forming apparatus 10 stored in ID storage section 15 and a password to the host 20. When the host 20 receives normally the ID information transmitted from the image forming apparatus 10, the host 20 sends ACK to the image forming apparatus 10.

On the host 20, confirmation of transmitted data is judged from information stored in ID storage section 25, concerning whether ID information of the image forming apparatus 10 received from the image forming apparatus 10 is matched with the password or not, or whether the image forming apparatus is one that is administrated by the host 20 itself or not (S 604). Then, data confirmation is completed, and the results of the confirmation are sent to the image forming apparatus 10. After receiving the results of the confirmation, the image forming apparatus 10 returns ACK to the host 20 when the receipt is normal.

Then, the image forming apparatus 10 transmits to the host 20 the rewriting program information request. The host 20 sends ACK back to the image forming apparatus 10 when the receipt is normal, after receiving the rewriting program information request. Then, the host 20 sends back to the image forming apparatus 10 the rewriting program information stored in the administrative storage section 22 at that time, as a reply of rewriting program information. The image forming apparatus 10, after receiving the reply of rewriting program information, returns ACK to the host 20 when the receipt is normal.

Then, the image forming apparatus 10 checks the current version of its control program (first program) stored in the first storage section 12 based on version information of ID storage section 15 (S 605).

Next, a judgment is formed from information (version information) of the received rewriting program (second program) and from information (version information) of its program (first program) stored in ID storage section 15, whether its program (first program) is of an old version compared with upgraded version and bug-corrected version for the program (second program) in host 20 or not, namely, whether the rewriting program (second program) needs to be downloaded or not (S 606).

This judgment can also be formed depending on whether the rewriting program is more updated than its own program or not based on program information correlated with its (present time) own program (information of date of preparation, information of date for storage, version information, history information, and information of a type of image forming apparatus) and on rewriting program information correlated with a rewriting program (information of date of preparation, information of date for storage, version information, history information, and information of a type of image forming apparatus).

When the image forming apparatus 10 decides that downloading is necessary, the rewriting program is selected first (the number of the programs that need to be rewritten is not always one because there are plural programs as stated above) (S 608).

After selecting, the image forming apparatus 10 transmits to host 20 a rewriting program request that requests to transmit the selected rewriting program. After receiving the rewriting program request, the host 20 returns ACK to the image forming apparatus 10 when the rewriting program request was received normally by the host 20. Then, the host 20 first sends back rewriting program data information 1 such as an amount of data (data length) of the rewriting program to the image forming apparatus 10 as a response to the rewriting program request, together with rewriting program ID. After receiving the rewriting program data information 1, the image forming apparatus 10 returns ACK to the host 20 when the rewriting program data information 1 was received normally by the image forming apparatus 10. Incidentally, when an amount of data (total amount of one rewriting program) exceeds a receivable size on the image forming apparatus 10, NACK (rejection) information is returned to terminate communication, or to acquire the following rewriting program. After receiving ACK, the host 20 transmits continuously rewriting program data information 2 representing information relating to a transmission method such as transfer block information or compression information to the image forming apparatus 10 as a response to the rewriting program request, together with rewriting program ID. After receiving the rewriting program data information 1, the image forming apparatus 10 returns ACK to the host 20 when the rewriting program data information was received normally by the image forming apparatus 10.

After receiving ACK, the host 20 returns ACK actually to the image forming apparatus 10 as a response to the rewriting program request. In this case, in the transition method shown in the rewriting program data information 2, namely, for replying for each block unit, the image forming apparatus 10 who received ACK conducts data receiving processing for the received data such as accumulating in a memory, combining plural blocks and decompressing of compression. After receiving the rewriting program, the image forming apparatus naturally returns ACK, for each receiving, to the host 20 when the receiving is normal, and the image forming apparatus sends the following block after ACK is received by the host 20.

In this way, the receiving of the rewriting program and data receiving processing are repeated in the image forming apparatus 10 until the data corresponding to an amount of data shown in the rewriting program data information 1 are processed (repetition 1 in the figure) (S 609).

The host 20 replies notification of last data to the image forming apparatus 10 after replying of the last block is completed. After receiving the notification of last data, the image forming apparatus returns ACK to the host 20 when the notification of the last data was received normally by the image forming apparatus.

The image forming apparatus 10 that returned ACK to the host 20 decides completion of acquisition of the rewriting program (S 610).

Namely, the image forming apparatus 10 decides whether it is necessary to download another rewriting program or not, and when downloading is necessary, the sequence returns to the rewriting program selection, and repetition 2 in the figure is repeated until the downloading becomes unnecessary.

On the other hand, if the acquisition of the rewriting program is decided to be completed, the image forming apparatus 10 transmits a notification for the end of communication to the host 20. Receiving this signal, the host 20 disconnects the line to the image forming apparatus 10 (S 611).

The image forming apparatus 10 that transmitted the notification for the end of communication to the host 20 decides, based on rewriting program information and rewriting program data information 1, whether the downloaded (to be transmitted (replied) to meet the request of the source) rewriting program can really be rewritten or not, further, whether the downloaded rewriting program was downloaded accurately or not.

After that, the image forming apparatus 10 judges the condition under which the program rewriting can be conducted. In this judgment, whether the program to be rewritten is used or not for conducting rewriting of the program is judged as a minimum judgment (if it is not used, rewriting can be conducted), and further judgment is formed for rewriting more safely whether a memory to be used as an operation area of CPU representing control section 13 is empty or not, because this memory is used for rewriting (if the memory is empty, rewriting can be conducted). When the rewriting is judged to be possible, the image forming apparatus 10 itself conducts processing to rewrite to the rewriting program based on the prescribed program (S 612).

Incidentally, in judgment in S 606, when rewriting is judged to be unnecessary, these processes (S 608-S 612) are not conducted.

As stated above, it is also possible to conduct processing that avoids a firewall, by doing through telephone lines.

### SEVENTH EXAMPLE

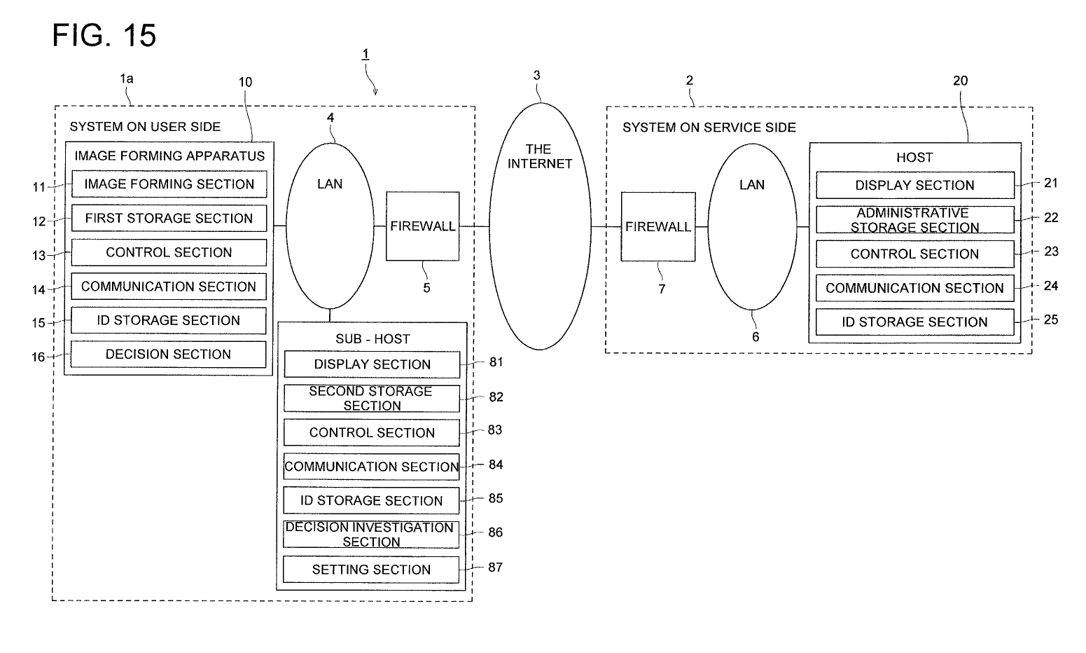

Next, the seventh example of the invention will be explained as follows, referring to FIG. 15. Incidentally, explanation of the structures in the present example which are substantially the same as those in the first example will be omitted, and different portions only will be explained.

In the first example described earlier, there was described an example wherein the image forming apparatus 10 accesses directly to the host 20. However, it is also possible for the image forming apparatus 10 to download the rewriting program indirectly, without accessing directly to the host 20 to download the rewriting program. In the present example, there will be explained an example wherein the image forming apparatus 10 downloads the rewriting program indirectly.

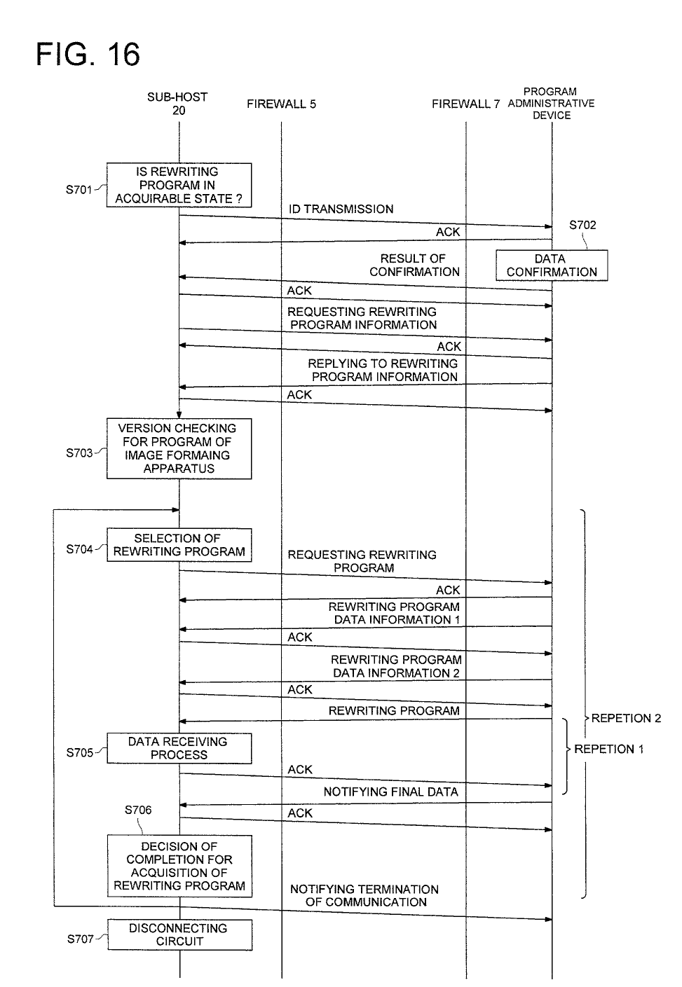

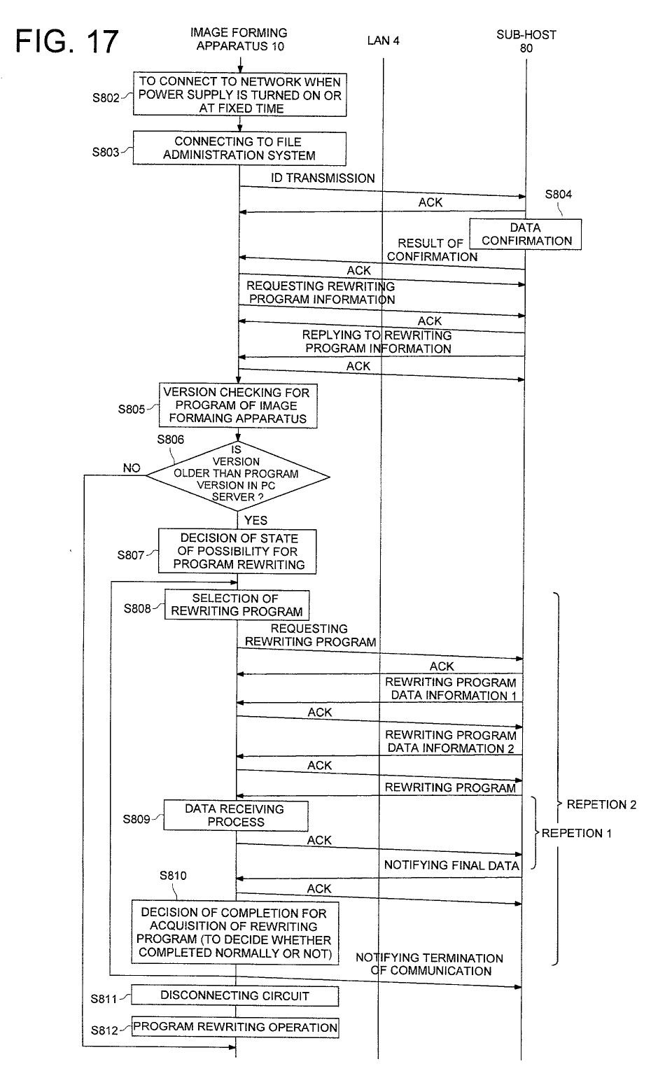

FIG. 15 is a block diagram showing the overall structure of the image forming system. FIG. 16 and FIG. 17 represent a sequence diagram showing rewriting procedures. Incidentally, FIG. 15 is basically the same as the block diagram in FIG. 1 (the same functions and portions are given the same symbols), and different points only will be explained, and explanation for other points will be omitted because they are the same as those in FIG. 1 (despite the same symbols, points explained below are different).

In the present image forming system 200, sub-host 80 is added to system on user side 1 in FIG. 1. The sub-host 80 is an administrative apparatus that administrates image forming apparatus 10 that is connected to LAN 4 (in detail, connected to be inside the firewall 5 when viewed from the LAN 4 side) (and other plural image forming apparatuses), and is one that obtains and stores the rewriting program of the image forming apparatus which is administrated, from the host 20 through LAN 4, firewall 5 and the internet 3. To be more exact, the sub-host 80 grasps the state of the image forming apparatus administrated by the sub-host 80, namely, in this example, grasps the state (version and others) of the program of the image forming apparatus 10, and thereby obtains and stores the rewriting programs of image forming apparatuses administrated by the sub-host 80. This sub-host 80 has therein display section 81, second storage section 82, control section 83, communication section 84, ID storage section 85, decision investigation section 86 and decision section 87.

The display section 81 is a display section on which the states of image forming apparatuses are displayed so that the state of the image forming apparatus may be grasped. Namely, observation of the display makes it possible to identify the version of a program and the image forming apparatus on which the program is mounted. Further, this display section 81 can display also the rewriting program obtained from the host 20.

Second storage section 82 is a storage section that is, for example, a flash memory which stores upgraded versions of various programs of an image forming apparatus administrated by sub-host 80 that is downloaded from the host 20 and rewriting programs which have subjected to bug correction are stored.

ID storage section 85 is a storage section that stores various types of ID information. ID information to be stored in the ID storage section 85 includes information of sub-host 80 (such as serial numbers for specifying sub-host 80 univocally), a password to authenticate for communication with image forming apparatus 10, a password to authenticate for communication with host 20, a serial number of an image forming apparatus administrated by the regular sub-host 80, various types of program information stored in first storage section 12 of an image forming apparatus administrated by the sub-host 80, and rewriting program information (including (information of a date on which a program was prepared, information of a date on which a program was stored, version information of a program, information of a program history, and information of an image forming apparatus type that specifies a type of image forming apparatus to be subjected to rewriting).

Owing to the sub-host 80 provided, ID information to be stored in ID storage section 15 of image forming apparatus 10 includes various types of program information, ID information (serial number) of the image forming apparatus for specifying the image forming apparatus 10 univocally, information of sub-host 80 that administrates the image forming apparatus 10 and a password to authenticate for communication with sub-host 80. In the same way, ID information to be stored in ID storage section 25 of host 25 includes information of host 20, a password to authenticate for communication with sub-host 80, information (serial number) of sub-host 80 administrated by the regular host 20 and rewriting program information stored in administrative storage section 22.

Decision investigation section 86 judges whether it is the time for image forming apparatus 10 to rewrite a program or not, and obtains information for setting rewritable timing of image forming apparatus 10 for investigation.

Setting section 86 (setting means) is one to set the rewriting timing of image forming apparatus 10 and the timing (unused time zone stated above).

(Processing Between Host-Sub-Host)

Next, rewriting procedures in the present example will be explained. First, procedures for downloading the rewriting program from host 20 to sub-host 80 will be explained referring to FIG. 16.

First, sub-host 80 judges whether a state is rewriting program obtainable state or not (S 701). In this case, the judgment for the obtainable state is formed by judging whether communication 84 is open (no other operation is conducted) or not (if it is open, the state is obtainable state), because communication section 84 is used for obtaining, for example, and by judging whether the memory is open or not, because a memory used as an operation area of CPU representing control section 83 is used for downloading.

Then, if the state is rewriting program obtainable state, sub-host 80 transmits ID information (serial number) and a password stored in ID storage section 85 to host 20 through LAN4, firewall 5, the internet 3, firewall 7 and LAN6, by setting a target for transmission based on information of host 20 administrating sub-host 80 stored in ID storage section 85. Receiving ID information transmitted from the sub-host 80, the host 20 sends back ACK showing the normal receiving to sub-host 80.

On the host 20, confirmation of transmitted data is judged from information stored in ID storage section 25, concerning whether ID information of the sub-host 80 received from the sub-host 80 is matched with the password or not, or whether the sub-host 80 is one that is administrated by the host 20 itself or not (S 702).

Then, data confirmation is completed, and a result of confirmation is sent back to the sub-host 80 as a reply for ID transmission. The sub-host 80, after receiving the result of the confirmation, sends back ACK to host 20 when the result of the confirmation is received normally.

Then, the sub-host 80 transmits to host 20 the rewriting program information request which requests to transmit information of rewriting program stored in administrative storage section 22 of the host 20. The host 20 sends ACK back to the sub-host 80 when receiving normally, after receiving the rewriting program information request. Then, as a reply for this request, the host 20 sends back to the image forming apparatus 10 the rewriting program information stored in the administrative storage section 22 at that time (namely, rewriting program information stored in the ID storage section 25), as a reply of rewriting program information. The sub-host 80, after receiving the reply of rewriting program information, sends back ACK to host 20 when the reply of rewriting program information is received normally.

Then, the sub-host 80 conducts version check of programs of an image forming apparatus (S 703). Namely, the sub-host 80 judges whether version-upgraded rewriting programs and bug-corrected rewriting programs are present in host 20 or not, namely, whether download of the rewriting program is necessary or not, from the received information of rewriting program and from program information of the image forming apparatus controlled by sub-host 80 stored in ID storage section 85. This judgment can be formed depending on whether the rewriting program is more updated than the program or not based on program information correlated with its (present time) own program (information of date of preparation, information of date for storage, version information, history information, and information of a type of image forming apparatus) and on rewriting program information correlated with a rewriting program (information of date of preparation, information of date for storage, version information, history information, and information of a type of image forming apparatus).

When the sub-host 80 judges that downloading is necessary, the rewriting program is selected first (the number of the programs that need to be rewritten is not always one because there are plural programs as stated above and plural image forming apparatuses are controlled) (S 704).

After selecting, the sub-host 80 transmits to host 20 a rewriting program request that requests to transmit the selected rewriting program. After receiving the rewriting program request, the host 20 returns ACK to the sub-host 80 when the rewriting program request was received normally by the host 20. Then, the host 20 first sends back rewriting program data information 1 such as an amount of data (data length) of the rewriting program to the sub-host 80 as a response to the rewriting program request, together with rewriting program ID. After receiving the rewriting program data information 1, the sub-host 80 returns ACK to the host 20 when the rewriting program data information 1 was received normally by the image forming apparatus 10. After receiving ACK, the host 20 transmits continuously rewriting program data information 2 representing information relating to a transmission method such as transfer block information or compression information to the sub-host 80 as a response to the rewriting program request, together with rewriting program ID. After receiving the rewriting program data information 1, the sub-host 80 returns ACK to the host 20 when the rewriting program data information was received normally by the sub-hold 80.

After receiving ACK, the host 20 returns ACK actually to the sub-host 80 as a response to the rewriting program request. In this case, in the transition method shown in the rewriting program data information 2, namely, for replying for each block unit, the sub-host 80 tha received ACK conducts data receiving processing for the received data such as accumulating in a memory, combining plural blocks and decompressing of compression. After receiving the rewriting program, the sub-host 80 naturally returns ACK, for each receiving, to the host 20 when the receipt is normal, and the image forming apparatus sends the following block after ACK is received by the host 20.

In this way, the receiving of the rewriting program and data receiving processing are repeated in the sub-host 80 until the data corresponding to an amount of data shown in the rewriting program data information 1 are processed (repetition 1 in the figure) (S 705).

The host 20 replies notification of last data to the sub-host 80 after replying of the last block is completed. After receiving the notification of last data, the sub-host 80 returns ACK to the host 20 when the notification of the last data was received normally by the image forming apparatus.

The sub-host 80 that returned ACK to the host 20 decides completion of acquisition of the rewriting program (S 706). Namely, the image forming apparatus 10 decides whether it is necessary to download another rewriting program or not, and when downloading is necessary, the sequence returns to the rewriting program selection, and repetition 2 in the figure is repeated until the downloading becomes unnecessary.

On the other hand, if the acquisition of the rewriting program is decided to be completed, the sub-host 80 transmits a notification for the end of communication to the host 20. Receiving this signal, the host 20 disconnects the line to the sub-host 80 (S 707).

In this way, the rewriting programs of the image forming apparatus administrated by the sub-host 80 are stored in second storage section 82 of the sub-host 80. Incidentally, from the host 20 to the sub-host 80, the obtaining procedures like those in the first example can be started by judging if the time is rewriting program obtainable time or not, or it is possible to start the obtaining procedures wherein the figure shows that the download instruction has been transmitted from the host 20 to the sub-host 80 as in the third and fourth examples. (Processing between an image forming apparatus and a sub-host)

Next, the procedures for image forming apparatus 10 to download rewriting programs stored in second storage section 82 of sub-host 80 and thereby to rewrite the programs will be explained as follows, referring to FIG. 17.

First, the power supply is turned on by operating a main power supply button and others on the image forming apparatus 10, or, when the unused time zone is reached, processing for conducting connection with a network based on a network connection program is implemented on the image forming apparatus 10 (S 802).

Then, after being connected with the network, there is implemented processing to connect with sub-host 80 of a file administrating system (S 803).

Then, the image forming apparatus 10 transmits ID information (serial number) and a password of image forming apparatus 10 stored in ID storage section 15 to sub-host 80 through LAN4, by setting a target based on information of sub-host 80 administrating the image forming apparatus 10, that information being stored in ID storage section 15. Receiving ID information transmitted from the image forming apparatus 10, the sub-host 80 sends back normal receiving signals (ACK) showing the normal receipt to the image forming apparatus 10. In the image forming apparatus 10, if no ACK is received, the image forming apparatus 10 naturally transmits information again, assuming that transmission was failed (this failure of transmission is applied to each of the following cases of information transmission, and explanation thereof will be omitted).

In the sub-host 80, a judgment is formed for whether ID information received from image forming apparatus 10 agrees with a password or not, or whether it is an image forming apparatus controlled by itself or not, thus, confirmation of data transmitted is decided from information stored in ID storage section 25 (S 804).

Then, data confirmation is completed, and a result of confirmation is sent back to the image forming apparatus 10 as a reply for ID transmission. The image forming apparatus 10, after receiving the result of the confirmation, sends back ACK to sub-host 80 when the result of the confirmation is received normally.

Then, the image forming apparatus 10 transmits to sub-host 80 the rewriting program information request which requests to transmit information of rewriting program stored in administrative storage section 22 of the sub-host 80. The sub-host 80 sends ACK back to the image forming apparatus 10 when receiving normally, after receiving the rewriting program information request. Then, as a reply for this request, the sub-host 80 sends back to the image forming apparatus 10 the rewriting program information stored in second storage section 82 at that time (namely, rewriting program information stored in the ID storage section 85), as a reply of rewriting program information. The image forming apparatus 10, after receiving the reply of rewriting program information, sends back ACK to sub-host 80 when the reply of rewriting program information is received normally.

Then, the image forming apparatus 10 checks the present version of its own control program (first program) stored in first storage section 12 based on version information of ID storage section 15 (S 805).

Next, a judgment is formed from information (version information) of the received rewriting program (second program) and from information (version information) of its program (first program) stored in ID storage section 15, whether its program (first program) is of an old version compared with upgraded version and bug-corrected version for the program (second program) in sub-host 80 or not, namely, whether the rewriting program (second program) needs to be downloaded or not (S 806).

Incidentally, this judgment can also be formed depending on whether the rewriting program is more updated than its own program or not based on program information correlated with its (present time) own program (information of date of preparation, information of date for storage, version information, history information, and information of a type of image forming apparatus) and on rewriting program information correlated with a rewriting program (information of date of preparation, information of date for storage, version information, history information, and information of a type of image forming apparatus).

When the image forming apparatus 10 decides that downloading is necessary, the rewriting program is selected first (the number of the programs that need to be rewritten is not always one because there are plural programs as stated above) (S 808).

After selecting, the image forming apparatus 10 transmits to host 20 a rewriting program request that requests to transmit the selected rewriting program. After receiving the rewriting program request, the sub-host 80 returns ACK to the image forming apparatus 10 when the rewriting program request was received normally by the sub-host 80. Then, the sub-host 80 first sends back rewriting program data information 1 such as an amount of data (data length) of the rewriting program to the image forming apparatus 10 as a response to the rewriting program request, together with rewriting program ID. After receiving the rewriting program data information 1, the image forming apparatus 10 returns ACK to the sub-host 80 when the rewriting program data information 1 was received normally by the image forming apparatus 10. Incidentally, when an amount of data (total amount of one rewriting program) exceeds a receivable size on the image forming apparatus 10, NACK (rejection) information is returned to terminate communication, or to acquire the following rewriting program. After receiving ACK, the sub-host 80 transmits continuously rewriting program data information 2 representing information relating to a transmission method such as transfer block information or compression information to the image forming apparatus 10 as a response to the rewriting program request, together with rewriting program ID. After receiving the rewriting program data information 1, the image forming apparatus 10 returns ACK to the host 20 when the rewriting program data information was received normally by the image forming apparatus 10.

After receiving ACK, the sub-host 80 returns ACK actually to the image forming apparatus 10 as a response to the rewriting program request. In this case, in the transition method shown in the rewriting program data information 2, namely, for replying for each block unit, the image forming apparatus 10 that received ACK conducts data receiving processing for the received data such as accumulating in a memory, combining plural blocks and decompressing of compression. After receiving the rewriting program, the image forming apparatus naturally returns ACK, for each receiving, to the sub-host 80 when the receiving is normal, and the image forming apparatus sends the following block after ACK is received by the sub-host 80.

In this way, the receiving of the rewriting program and data receiving processing are repeated in the image forming apparatus 10 until the data corresponding to an amount of data shown in the rewriting program data information 1 are processed (repetition 1 in the figure) (S 809).

The sub-host 80 replies notification of last data to the image forming apparatus 10 after replying of the last block is completed. After receiving the notification of last data, the image forming apparatus returns ACK to the sub-host 80 when the notification of the last data was received normally by the image forming apparatus.

The image forming apparatus 10 that returned ACK to the sub-host 80 decides completion of acquisition of the rewriting program (S 810).

Namely, the image forming apparatus 10 decides whether it is necessary to download another rewriting program or not, and when downloading is necessary, the sequence returns to the rewriting program selection, and repetition 2 in the figure is repeated until the downloading becomes unnecessary.

On the other hand, if the acquisition of the rewriting program is decided to be completed, the image forming apparatus 10 transmits a notification for the end of communication to the sub-host 80. Receiving this signal, the sub-host 80 disconnects the line to the image forming apparatus 10 (S 811).

The image forming apparatus 10 that transmitted the notification for the end of communication to the sub-host 80 decides, based on rewriting program information and rewriting program data information 1, whether the downloaded (to be transmitted (replied) to meet the request of the source) rewriting program can really be rewritten or not, further, whether the downloaded rewriting program was downloaded accurately or not.

After that, the image forming apparatus 10 judges the condition under which the program rewriting can be conducted. In this judgment, whether the program to be rewritten is used or not for conducting rewriting of the program is judged as a minimum judgment (if it is not used, rewriting can be conducted), and further judgment is formed for rewriting more safely whether a memory to be used as an operation area of CPU representing control section 13 is empty or not, because this memory is used for rewriting (if the memory is empty, rewriting can be conducted). When the rewriting is judged to be possible, the image forming apparatus 10 itself conducts processing to rewrite to the rewriting program based on the prescribed program (S 812).

Incidentally, in judgment in S 806, when rewriting is judged to be unnecessary, these processes (S 808-S 812) are not conducted.

As stated above, the present example makes it possible to conduct rewriting processing by using the sub-host, while enjoying the same action and effect as in the examples stated above.

### EIGHTH EXAMPLE

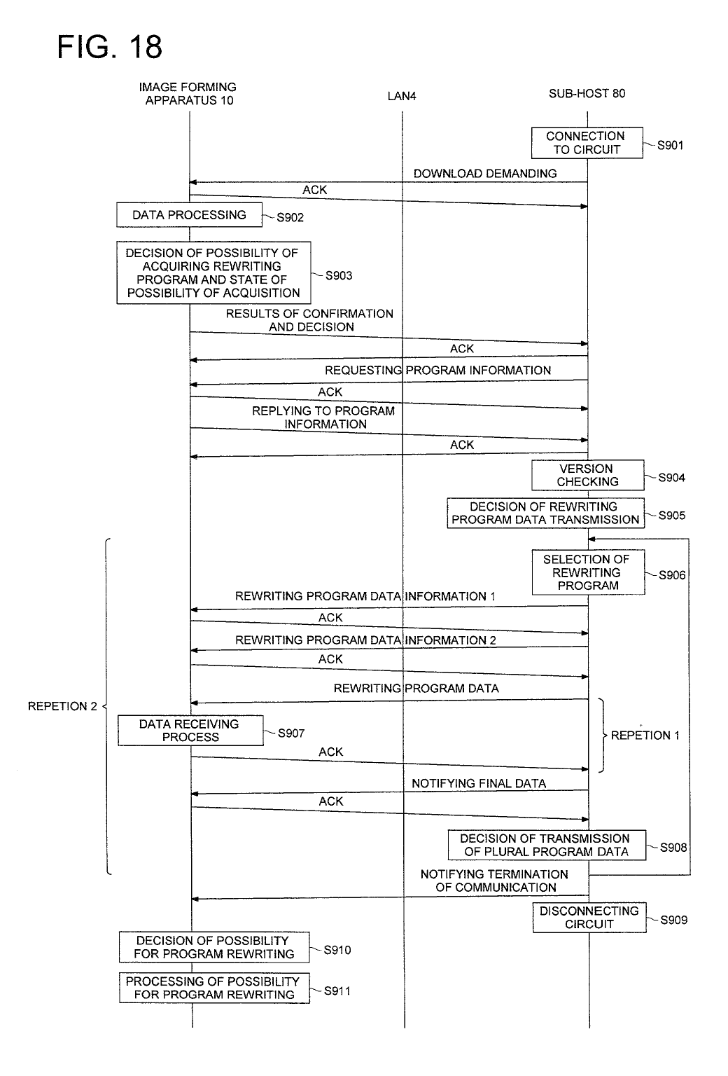

Next, the eighth example of the invention will be explained as follows, referring to FIG. 18. Incidentally, explanation of the structures in the present example which are substantially the same as those in the seventh example will be omitted, and different portions only will be explained.

Incidentally, delivery and receipt of information between sub-host 80 and image forming apparatus 10 are not subject to restriction of passing information that is put by firewall 5, because the delivery and receipt of information are those on LAN 4 in the firewall 5. In the LAN 4, therefore, the degree of freedom for mutual delivery and receipt of information is increased. Accordingly, even in the method shown in FIG. 18, it is possible to arrange on the user side, without lowering the security function by firewall 5 (without relaxing the restriction), so that image forming apparatus 10 obtains rewriting programs from sub-host 80. Incidentally, procedures for obtaining rewriting programs in FIG. 18 are mostly the same (host 20 is replaced with sub-host 80) as those in the third example stated above, and thereby, explanation of them will be omitted here.

Incidentally, although sub-host 80 obtains information from the host through the internet 3 in this example, it is also possible to arrange so that information of host 20 may be obtained through a removal storage (recording medium) such as FD, MD, CD and DVD.

Further, host 20 transmits to image forming apparatus 10 by dividing into rewriting program data information 1 and rewriting program data information 2 in the example above. However, it is also possible to transmit without dividing.

In the example above, it is preferable that image forming apparatus 10 transmits ID information of the image forming apparatus 10 and the rewritten program information (rewriting program information) to host 20 after rewriting is completed on rewriting program, and on the host 20, display section 21 displays, based on the transmitted information, that rewriting for the image forming apparatus 10 has been completed, thus, the state of program of the image forming apparatus 10 can be grasped. It is naturally possible to learn on the host 20 side whether the image forming apparatus 10 has downloaded or not, and it is more preferable that the foregoing is also displayed together on the display section 21.

As stated above, a service engineer rewrites a program of an image forming apparatus to rewriting program on a remote control basis to achieve reduction of time and expense without visiting a place of installation of the image forming apparatus, and thus, the image forming apparatus can be administrated in a more detailed way. In addition, the latest program can be used, which is convenient for users.

In the example above, the image forming apparatus 10 obtains a rewriting program when it judges (version check) that the rewriting program stored in administrative storage section 22 is a rewriting program to be rewritten from the program stored in the first storage section 12, before downloading the rewriting program, which prevents that transaction (information transfer density) of the internet 3 and LAN 4 turns out to be excessive, and is preferable. However, it is also possible to arrange so that a rewriting program stored in the administrative storage section 22 is downloaded on the image forming apparatus 10 (or sub-host 80), then, this obtained rewriting program is judged whether it is a rewriting program to be rewritten from the program stored in the first storage section 12 or not, and when the obtained rewriting program is judged to be a rewriting program to be rewritten, the program stored in the first storage section 12 is rewritten to the rewriting program.

In the example above again, each of programs and rewriting programs is correlated with information of date of preparation, information of date for storage, version information, history information, and information of a type of image forming apparatus (at least one of these may be acceptable), and based on these pieces of information, the rewriting program is judged whether it is a rewriting program to be rewritten from the program stored in the first storage section 12 or not. It is therefore possible update to the latest program including version upgrading, or it is possible to cope with the program prepared in particular (custom-made program).

As stated in the third and fourth examples, the image forming apparatus 10 accesses system on service side 2 based on the downloading instruction transmitted from the system on service side 2 to obtain the rewriting program stored in the administrative storage section 22, and rewrites the program stored in the first storage section 12 into the rewriting program. It is therefore possible to obtain the rewriting program at the optimum timing to rewrite.

Since the download instruction is transferred through the network (telephone line network) which is different from a network (the internet 3) through which the rewriting program is transferred, timing is more accurate.

A sub-host having second storage section 82 that stores programs is provided as an image forming system, and sub-host 80 accesses the system on service side 2 through a general network (the internet 3) to obtain the rewriting program stored in administrative storage section 22, and stores it in second storage section 82, while, image forming apparatus 10 obtains the rewriting program stored in the second storage section 82 through a user network (LAN 4) to rewrite the program stored in the first storage section 12 into the rewriting program. Owing to this, the number of rewriting programs to be obtained through the internet 3 can be only one, which makes it possible to achieve reduction of time, and makes a user itself to conduct centralized administration for image forming apparatuses in LAN 4 with sub-host 80.

Since operations are made during an unused time zone or in the course of warm-up in the example explained above, it is possible, during execution of a program, to eliminate troubles caused by rewriting of the program, without overweighting the image forming apparatus 10 used.

In the explanation above, it is preferable that a storage section for storing the obtained (received) rewriting program (program before rewriting) and first storage section 12 in which programs are stored are separate each other, but it is also possible to divide an area in the same hardware (HDD, flash memory, nonvolatile memory).

In any case in various examples described in the aforesaid explanation, a judgment for whether the program is to be rewritten or not may be formed either on the image forming apparatus side or on the host (or sub-host) side, for both cases of accessing from the image forming apparatus to the host and accessing from the host to the image forming apparatus (or, from the sub-host to the image forming apparatus, or from the host to the sub-host).

### NINTH EXAMPLE

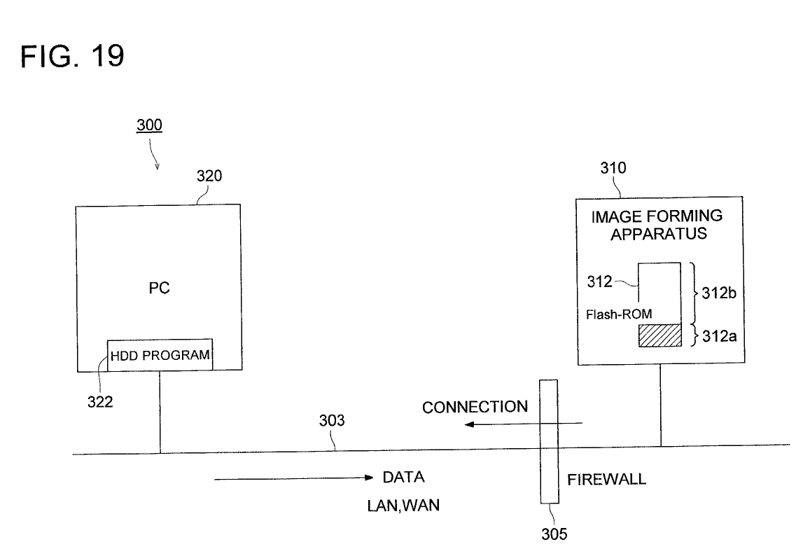

Next, the ninth example of the invention will be explained as follows, referring to FIGS. 19-21. Incidentally, explanation of the structures in the present example which are substantially the same as those in the first example will be omitted, and different portions only will be explained. FIG. 19 is an illustration showing the schematic structure of the overall image forming system of the present example.

(System Structure)

As shown in FIG. 19, image forming system 300 of the present example has therein image forming apparatus 310, PC server 320 representing an administrative apparatus in a file administrative system administrating the image forming apparatus 310, network 303 that connects the PC server 320 with the image forming apparatus 310, and firewall 305 on the user side existing in the network 303.

The image forming apparatus 310 has flash ROM 312 representing the first storage means, and this flash ROM 312 includes rewritable first area 312b and second area 312a that is not rewritable. This flash ROM 312 has a main program (first program) that controls the image forming apparatus 310 in terms of operation.

Incidentally, for the first area 312b and the second area 312a, it is possible to set the area by making the second area 312a, for example, to be protected. Incidentally, this processing of protection can be conducted by the illustrated setting means.

The PC sever 320 has therein hard disk 322 that is an administrative storage means. In this hard disk 322, there are stored new main program (second program) and others for rewriting a main program into a new program.

Incidentally, the network 303 includes, for example, a network such as LAN and WAN, or an the internet. It is preferable to use a protocol such as FTP for connection from the image forming apparatus 310 side to PC 320, because there is a fault such as firewall 305 in this network 303.

In the image forming system 1 as that stated above, when the rewriting request is forwarded from the image forming apparatus 310 side, the image forming apparatus 310 accesses PC server 320, then, conducts downloading based on the request for downloading new main program from hard disk 322 to obtain the new program, and conducts processing for rewriting main program of flash ROM 312 into the new main program.

What is peculiar in the present example in the structure wherein automatic restoration is possible even when processing is interrupted by broken wires in the course of rewriting process.

(Memory Structure)

The principle of the foregoing will be explained as follows, referring to the memory map of 312 in flash ROM.

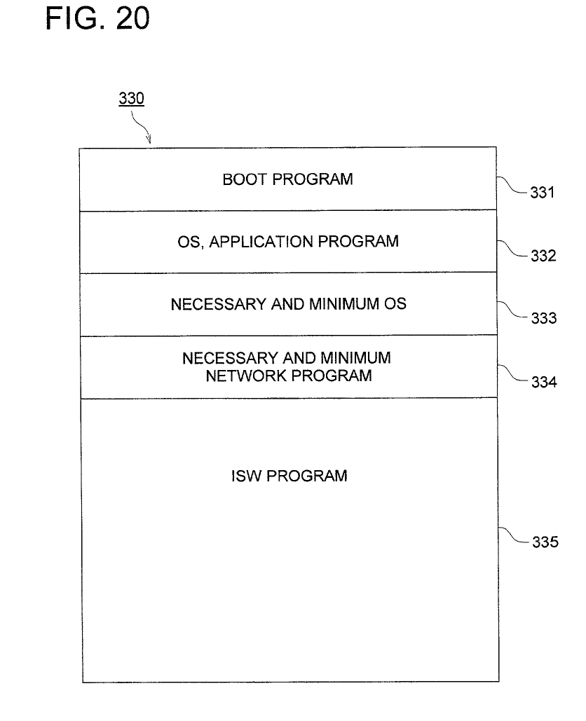

Flash ROM 312 in image processing apparatus 310 is divided as shown in FIG. 20 so that automatic connection restoration may be made possible by minimum OS, a network program or ISW program.

Memory area 330 in the flash ROM 312 forms BOOT program 331, OS (operating system), application program 332, necessary and minimum OS (operating system) 333, necessary and minimum network program 334 and rewriting program (In System Writer program, hereinafter referred to as ISW program) 335.

The BOOT program 331 is a starting program, and each program such as application or the like does not operate until the processing of the BOOT program 331 has been completed. Further, a program for checksum calculation for switching the start for necessary and minimum OS 333 and OS 332, and checksum for verification are prepared. Though this checksum includes various checksums, it is possible to use, for example, the one which is a complement of 1 after addition of data covering from the forefront data to the last data.

The necessary and minimum network program 334 is a program for connection to the network, and an example thereof is a communication protocol that can go through firewall 305. FTP, for example, can be given as this communication protocol.

The necessary and minimum OS 333 has only to own a function which is necessary for the network program to operate. Therefore, all functions equipped on OS of this kind are not always necessary.

In the present example, the “minimum program” that is necessary to access PC server 320 from image forming apparatus 310 and to obtain new main program for conducting rewriting processing means necessary and minimum OS 333, necessary and minimum network program 334 and ISW program 335.

An area of the aforesaid flash ROM 312 on which this “minimum program” is formed is made to be protected on a hardware basis or on a software basis so that rewriting may not be always conducted easily. This unrewritable area forms the aforesaid second area 312a. Incidentally, the “minimum program” can constitute, for example, a rewriting means of the invention.

Accordingly, rewritable first area 312b has thereon BOOT program 331, OS (operating system) and application program 332.

Further, hard disk 322 of PC server 320 is provided with a communication protocol which can communicate with the aforesaid image forming apparatus 310, and for other programs, the hard disk 322 has only to be provided with various programs each having a function of an ordinary server.

Incidentally, in the present example, “main program” (first program) for controlling operations of image forming apparatus 330 includes generally OS and application program 332. While, “new main program” (second program) to be downloaded includes generally new version OS and an application program. Further, ISW program 335 includes a program for rewriting necessary for rewriting the OS and application program 332 into new version OS and an application program and a program to give an instruction for downloading the new version OS and the application program from PC server 320 to obtain.

In memory area 330 having this structure, if the new main program as that stated above is downloaded and a line is broken during rewriting processing, OS (operating system) and application program 332 are damaged. Thereupon, image forming apparatus 310 stops, and the main power supply for the image forming apparatus 310 is turned off temporarily under the condition that the image forming apparatus 310 is suspended.

Next, after the main power supply is turned on, BOOT program 331 is started and it discovers that OS (operating system) and application program 332 are broken. Then, necessary and minimum OS 333 rises to operate necessary and minimum network program 334, and image forming apparatus 310 is connected to network 303 to access PC server 320 to obtain the new main program again with ISW program 335, thus, the rewriting processing is conducted.

(Processing Procedures)

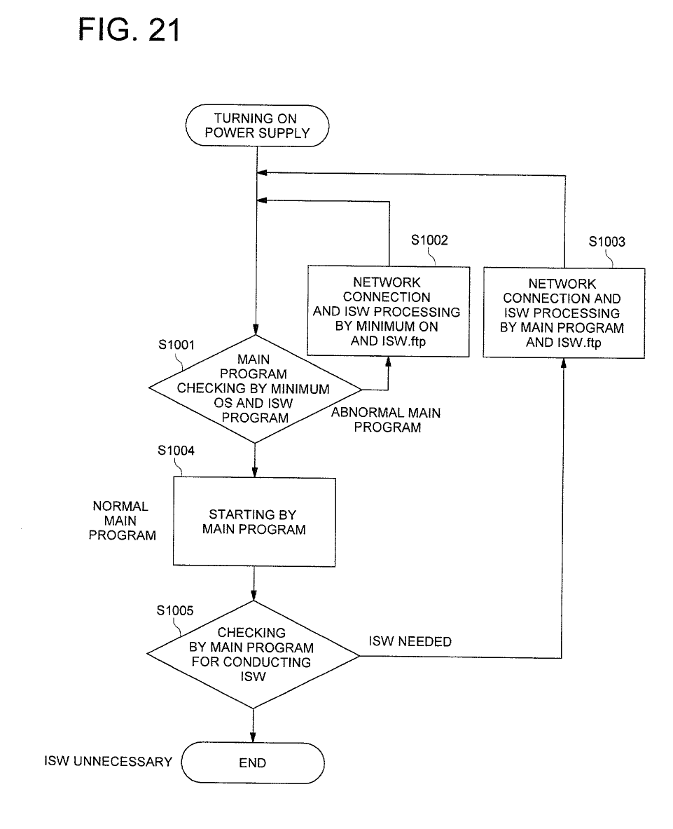

Next, details of the processing will be explained as follows, referring to FIG. 21. When the power supply is turned on first, the main program is checked by minimum OS 333 and ISW program 335 (S 1001).

In S 1001, if abnormality is discovered on the main program, the network connection by minimum OS 333, ISW program 335 and network program 334 and rewriting processing of ISW are conducted (S 1002) to return to S 1001.

In S 1001, on the other hand, if no abnormality is discovered on the main program, starting is conducted by the main program (S 1003).

Next, it is checked whether ISW (rewriting processing) is to be conducted by the main program or not (S 1004).

In S 1004, if ISW (rewriting processing) is judged to be necessary, the network connection by the main program, ISW program 335 and network program 334 and rewriting processing of ISW program 335 are conducted (S 1005) to return to S 1001.

In S 1004, on the other hand, if ISW (rewriting processing) by the main program is judged to be unnecessary, the processing is terminated.

In the present example, as stated above, the necessary and minimum program for accessing the network and thereby obtaining a new main program from PC server for rewriting is stored in the unrewritable second area which is protected by a storage means of an image forming apparatus in advance, and thereby, the necessary and minimum program in the second area operates in the case of abnormal termination caused by broken lines, and restoration is carried out easily.

Due to this, even when wires are broken, a service engineer does not need to visit the site of the accident for repair work, which is different from the way of taking measures in the past, and yet it is possible to restore so that the image forming apparatus may operate automatically under the new control program after turning on of the power, thus, it is possible to shorten a period of time during which a user cannot use the image forming apparatus.

### TENTH EXAMPLE

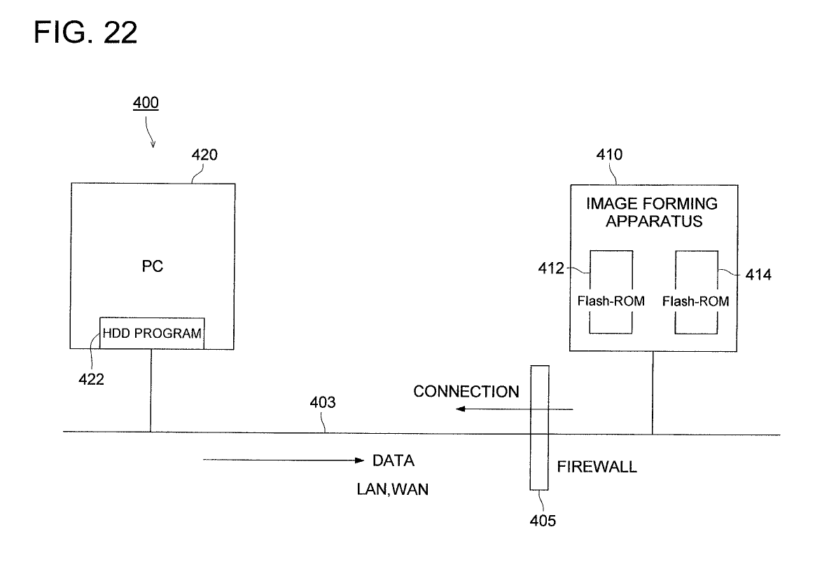

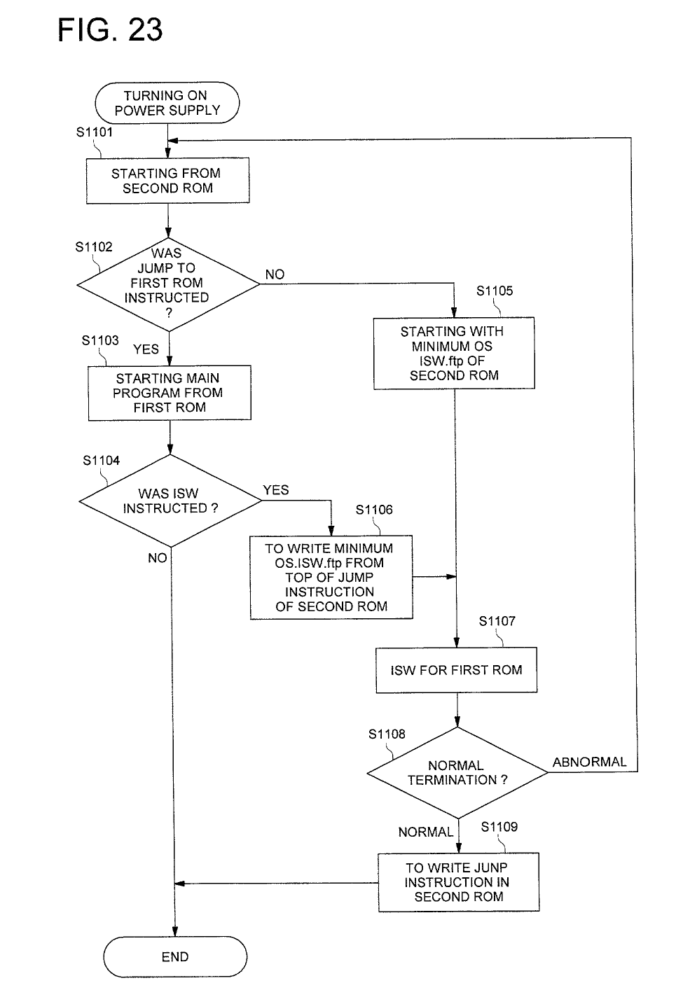

Next, the tenth example of the invention will be explained as follows, referring to FIGS. 22 and 23. Incidentally, explanation of the structures in the present example which are substantially the same as those in the ninth example will be omitted, and different portions only will be explained. FIG. 22 is an illustration showing the schematic structure of the overall image forming system of the present example.

As shown in FIG. 22, image forming system 400 of the present example has therein image forming apparatus 410, PC server 420 representing an administrative apparatus in a file administrative system administrating the image forming apparatus 410, network 403 that connects the PC server 420 with the image forming apparatus 410, and firewall 405 on the user side existing in the network 403.

The image forming apparatus 410 has flash ROM 412 representing the first storage means and flash ROM 414 representing the second storage means.

On the flash ROM 412, there are provided main program (first program) such as OS (operating system) and an application program for controlling operations of image forming apparatus 310, BOOT program, a network program and the aforesaid ISW program. Incidentally, it is preferable that the flash ROM 412 is made to be protected to make rewriting impossible.

On flash ROM 414, there is stored, for example, only a command for jumping to flash ROM 412.

Incidentally, image forming apparatus 410 is different from image forming apparatus 10 in, for example, the first example in terms of a structure of ROM, but the ROM function is mostly the same for both of them. Therefore, the control means that controls the image forming apparatus 410 controls in the ordinary operations so that the starting may be initiated by flash ROM 412.

The PC sever 420 has therein hard disk 422 that is an administrative storage means. In this hard disk 422, there are stored new main program (second program) and others for rewriting a main program into a new program.

Incidentally, the network 403 includes, for example, a network such as LAN and WAN, or an the internet. It is preferable to use a protocol such as FTP for connection from the image forming apparatus 410 side to PC server 420, because there is a fault such as firewall 405 in this network 403.

In the image forming system 400 as that stated above, when the rewriting request is forwarded from the image forming apparatus 410 side, the image forming apparatus 410 accesses PC server 420, then, conducts downloading based on the request for downloading new main program from hard disk 422 to obtain the new program, and conducts processing for rewriting main program of flash ROM 412 into the new main program.

What is characteristic in the present example, in this case, is the structure which makes it possible to restore automatically even when the rewriting processing is terminated abnormally in its final stage by broken wires or the like.

Namely, in image forming apparatus 410 in the present example, there are provided flash ROM 412 and flash ROM 414, and OS, application and network connection program are stored in the flash ROM 412, and only the command for jumping to the flash ROM 414 is stored in the flash ROM 414.

Under the situation stated above, setting is made so that starting is usually initiated from the flash ROM 414. When rewriting the flash ROM 412, minimum program for network connection to flash ROM 414 is copied. After normal termination, a command for jumping to the flash ROM 412 is written in the flash ROM 414. Owing to this, when there is abnormal termination of ISW program, automatic network connection is possible because starting is initiated from flash ROM 414.

Next, processing procedures based on the principle stated above will be explained as follows, referring to FIG. 23.

First, starting is initiated from flash ROM 414 (S 1101). Then, judgment is formed whether a command for jumping to flash ROM 412 is present in flash ROM 414 or not (S 1102). The processing program conducting this judgment can constitute, for example, a judgment means.

In this S 1102, when the command for jumping is judged not to be present, starting is conducted by necessary and minimum OS of flash ROM 414, ISW program and a network program (S 1105).

Next, flash ROM 412 is started by ISW program (S 1107). Then, judgment is formed whether the termination is normal or not (S 1108). The processing program for processing this judgment can constitute, for example, a judging means of the invention.

In S 1108, when the termination is judged not to be normal, the step returns to S 1101.

On the other hand, in S 1108, when the termination is judged to be normal, the processing to write a command for jumping in flash ROM 414 is conducted (S 1109).

On the other hand, in S 1102, when the command for jumping is judged to be present, the main program is started from flash ROM 412 (S 1103).

Next, there is conducted the processing of judging whether an instruction of ISW program is present or not (S 1104).

In this S 1104, when the instruction of ISW program is judged not to be present, the processing is terminated.

On the other hand, in S 1104, when the instruction of ISW program is judged to be present, the processing to write necessary and minimum OS, ISW program and network program from the top of a command for jumping of flash ROM 414 is conducted (S 1106), and the step advances to S 1107.

As stated above, the present example does not require the exclusive and minimum program like that in the tenth example, while enjoying the same action and effect as in the ninth example stated above, because flash ROM has only to be provided additionally.

Incidentally, it is also possible to employ the structure wherein the memory structure in the tenth example is used in the first storage means in the eleventh example.

### ELEVENTH EXAMPLE

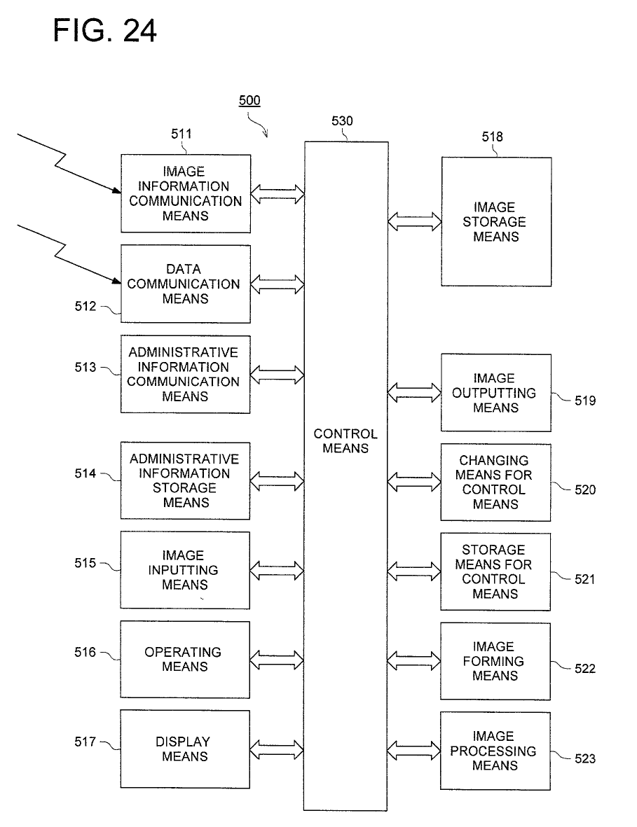

Next, the eleventh example of the invention will be explained as follows, referring to FIG. 24. Incidentally, explanation of the structures in the present example which are substantially the same as those in the first example will be omitted, and different portions only will be explained.

(Overall Structure)

First, prior to explanation of report output processing after rewriting processing which is a feature of the invention, there will be explained an overall schematic structure of the image forming apparatus of the invention, referring to FIG. 24. FIG. 24 is a functional block diagram showing the schematic structure of the image forming apparatus in the image forming system of the present example.

As shown in FIG. 24, image forming apparatus 500 of the present example is a compound apparatus having a facsimile function, a copying function and a printer function, and it is provided with image information communicating means 511 connected with a network for receiving image information from external information processing apparatus PC, data communicating means 512 that communicates in accordance, for example, with prescribed facsimile communication procedures, and sends and receives data through communication lines (telephone lines), administrative information communicating means 513 that sends and receives administrative information and control program by using the image information communicating means 511 or the data communicating means 512, administrative information storing means 514 that stores administrative information of the image forming apparatus 500, image inputting means 515 that is composed of a prescribed optical system and is a document reading means for reading images on a document, and with image storing means 518 that stores image information read by the image inputting means 515 and image information received by the data communicating means 512.

The image forming apparatus 500 further has therein image processing means 523 that conducts prescribed processing (magnification changing processing and processing for superposing images) on image information received or read and stores them in image storing means 518, image forming means 522 that forms images on a recording sheet as a recording medium, image output means 519 for outputting image information or data stored as a print, operating means 516 equipped with many key groups which conduct setting of various modes in transmission and inputting of telephone numbers of communication targets, display means 517 that functions as a designating means that designates magnification in image forming by using, for example, an LCD touch panel, control means 530 that controls each constituent portion according to a prescribed control program, storage means 521 representing a control means for storing a control program of the control means 530, and changing means (control program rewriting means) 520 of a control means for rewriting a control program.

Incidentally, a decoding means that decodes and extends received image information in the course of receiving, and a coding means that compresses and codes document image information in the course of transmitting, can be incorporated.

In addition, the image output means 519, the image forming means 522, the control means 530, the image information communicating means 511, the data communicating means 512, and the administrative information communicating means 513 all stated above can constitute a “control means” (that is different from the control means having the symbol 530 in FIG. 24 in the example) of the invention. In this case, it is also possible for the “control means” to control, after completion of rewriting processing, to output a report of termination of rewriting processing onto a facsimile receiving image tray, to control to facsimile-transmit a report of termination of rewriting processing to the designated target, to control to transmit a report of termination of rewriting processing to the designated target as an electronic mail, to control to output a report of termination of rewriting processing with an image forming means when rewriting processing is terminated and communication for confirming of rewriting from the administrative apparatus side are terminated, to control to output a report of termination of rewriting processing onto a facsimile receiving image output tray when rewriting processing is terminated and communication for confirming of rewriting from the administrative apparatus side are terminated, to control to facsimile-transmit a report of termination of rewriting processing to the designated target when rewriting processing is terminated and communication for confirming of rewriting from the administrative apparatus side are terminated, and to control to transmit a report of termination of rewriting processing to the designated target as an electronic mail when rewriting processing is terminated and communication for confirming of rewriting from the administrative apparatus side are terminated.

The changing means 520 of the control means, the storage means 521 of the control means and the control means 530 can constitute a rewriting means of the invention. Further, it is possible to constitute the image forming apparatus of the invention with the structure wherein facsimile functions only in image forming apparatus 400 representing a compound apparatus are extracted.

In the image information communicating means 511, various communication protocols (FTP, SMTP and so on) make it possible to download programs, or to transmit and receive an electronic mail.

The data communicating means 512 has a network control unit for conducting calling between itself and a public network such as NTT and for conducting connection control such as accepting call from many and unspecified targets, reverting and disconnection processing, and a communication modem that demodulates modulated signals transmitted through a public network in receiving to convert into digital received images, and modulates document image information so that it may be compatible with a frequency band of a public network in transmitting to convert into modulation signals.

The image inputting means 515 has a first mirror unit which is composed of ADF that can read both sides (Auto Document Feeder), an illumination lamp for scanning a document placed on a platen and of a mirror and moves horizontally, a second mirror unit which is composed of a pair of mirrors and moves to follow the first mirror unit, and a CCD imaging section on which the image obtained through exposure scanning is formed through a projection lens.

In the image processing means 523, digital image signals obtained through reading by the image inputting means 515, or digital image signals received by the data communicating means 512 are subjected, when necessary, to pretreatment conducted by an enlargement/reduction circuit and a density correction circuit, and is image-compressed by a compression/expansion circuit to be stored in image storing means 518. Then, this stored image is read and is expanded by the compression/expansion circuit to be outputted to image forming means 522.

The image forming means 522 has therein a laser optical system, a photoreceptor drum on which a pattern of static electricity (electrostatic latent image) is formed on the surface of the photoreceptor drum, a charging unit that charges the photoreceptor drum in advance, a developing unit in which toner charged negatively is stuck on the electrostatic latent image which then turns into a visible image, and a transfer unit that transfers the visible image formed with toner on the photoreceptor drum onto a sheet.

The image storage means 518 is composed of a general purpose memory housing therein data of composite images of plural types including a copy image memory in a copy area, a facsimile image memory in a facsimile area, each country font bit map data and water mark, stamps, dates, pages and numbering and of a nonvolatile memory. Further, a part of the facsimile image memory is assigned as a “confidential” box area that ensures a “confidential” box (mail box) storing therein information of “confidential” received.

In a copy function, a copy image memory is used, and document image information that is read by image inputting means 515 is stored in the copy image memory after the document image information is compressed.

In a facsimile function, a facsimile image memory is used, and when image information transmitted from a target is received by a communication modem, the image information is decoded by a decoding means, and then, compressed again to be stored in the facsimile image memory.

In a printer function, a copy image memory is used commonly, and image information transmitted from an outer information processing apparatus or the like is received by image information communication means 511 and is stored in the copy image memory after being subjected to the prescribed image processing by image processing means 523.

In the facsimile image memory, image information corresponding to, for example, 100 subjects are given numbers, and are filed to be stored in each directory indicated by each of the numbers as, for example, “confidential” box information. Each “confidential” box information stored as received information includes main scanning resolution and sub-scanning resolution for the maximum data size and a sheet width for the maximum data size.

The operating means 516 is composed of a touch-panel that receives operations and a display means 517 that is made of LCD which displays patterns and characters, both of which are arranged to be superposed, a display-operation section which is operated by pressing a touch-panel at the position displayed on LCD, a single-hand operation key for a single-hand operation dial for implementing single-hand operation transmission and multi-destination delivery, a key button for inputting telephone numbers composed of a ten-key including “0”-“9”, “*” key, and “#” key, a stop/clear button, and of a mode-change key for switching start/copy function, facsimile function and printer function.

In the facsimile function, only pressing down of a single-hand operation key after setting a document can usually conduct transmission to the desired target.

The control means 530 has therein an image control section that administrates and controls the state of each constituting section of a compound apparatus and controls image processing means 523, a printer control section that controls driving of image forming means 522, an operation control section that controls operating means 516, and a communication control section (data processing means, data communication control means) that controls data communicating means 512.

When a SUB signal is included in received signals obtained through data communication means 512, for example, an unillustrated CPU in the communication control section confirms whether it can be registered or not, and then, stores the received image data in the “confidential” box area in a facsimile image memory designated by the sub-address shown by the SUB signal, and stores information of receiving and others.

Next, procedures of receiving facsimile in this compound apparatus will be explained.

When the compound apparatus receives calling tone signals CNG transmitted from a facsimile machine on the sending side as a calling station having a F code function, CPU transmits a called station identification signal CED, and then, transmits calling terminal identification signal CSI and digital identification signal DIS.

Receiving this, the facsimile machine transmits sub-address signal SUB, digital command signal DCS, and further training check signal TCF, after transmitting transmission terminal identification signal TSI. Next, CPU judges whether it is possible to register in a “confidential” box designated by a sub-address included in sub-address signal SUB or not. If it judges that registration is possible, it transmits receiving preparation confirmation signal CFR. Receiving this, the facsimile machine transmits image signal PIX, and the compound apparatus starts receiving of image data.

Image information thus received is decoded by a decoding means, and then, is subjected to coding processing again, and this image information is written in a prescribed “confidental” box of a facsimile image memory, and further, received information in the facsimile image memory is updated.

The data communication means 512 transmits procedure termination signal EOP after completing transmission of image signal PIX, for example, and CPU transmits message confirmation signal MCF after confirming receiving of the procedure termination signal EOP. After this, this data communication means 512 transmits disconnection command signal DCN to terminate a series of communication.

(Characteristics of the Present Example)

What is characteristic in the present example is that a report of completion of rewriting processing is outputted from image outputting means 519 in a remote control system (the image forming system) when rewriting processing of new main program of new version is completed.

Incidentally, though there is given a facsimile received image tray as a target to which the image outputting means 519 outputs, it is also possible to output from image forming means 522, namely, from a sheet ejection tray of a copying machine when necessary.

In other words, it is difficult to get in touch when rewriting work has been completed, because the rewriting work is usually conducted at night when image forming apparatus 500 is not used by a user. For notifying a user that the rewriting work has been completed, it has been necessary to get in touch with the user in the following morning again. In the present example, however, it is possible to notify a user in writing when the user comes to image forming apparatus 200 to use it the following morning, by outputting the contents of the work as a report when the rewriting work has been completed. Therefore, a quantity of contact after work can be reduced in the case of much rewriting work.

(Processing Procedures)

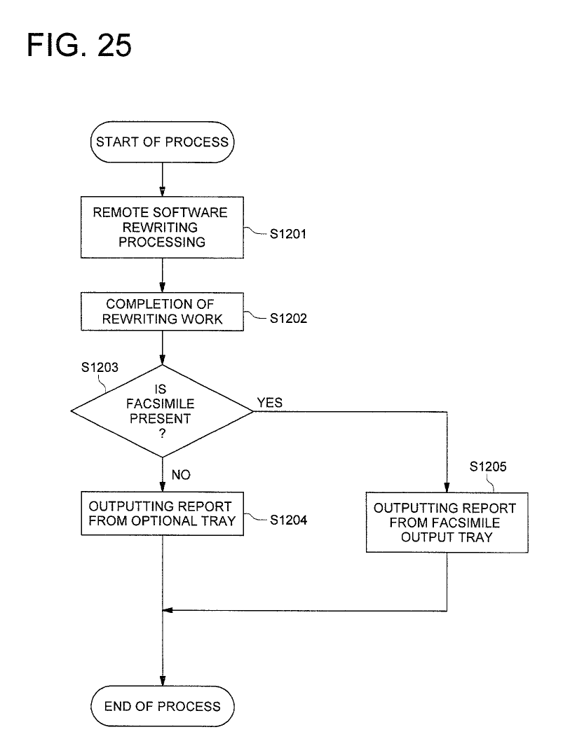

Next, details of the processing conducted by the image forming apparatus having the aforesaid structure when rewriting processing is conducted in the image forming system will be explained as follows, referring to FIG. 25.

FIG. 25 is a flow chart showing processing of report outputting after completion of rewriting processing in the image forming apparatus of the present example.

First, a remote control system (image forming system), namely, an image forming apparatus obtains new main program from an administrating apparatus, and processing such as rewriting processing is conducted (S 1201). The processing program that conducts this processing can constitute, for example, a rewriting means.

Next, after completion of rewriting work (S 1202), the processing for judging whether the facsimile function is present or not is carried out (S 1203).

When a facsimile is judged not to be present, a rewriting processing completion report is outputted from an optional tray (S 1204). On the other hand, when a facsimile is judged to be present, a rewriting processing completion report is outputted from a facsimile output tray.

Incidentally, a processing program that processes S 1202-S 1205 can constitute, for example, a control means.

As stated above, in the present example, when a remote rewriting work is terminated, an apparatus main body outputs a work completion report automatically by using an image outputting means or a communication means. Due to this, a user can receive the notification of completion even when an operator does not notify the completion of work formally.

Incidentally, each of the apparatus and the method of the invention has been explained referring to its specific example, and persons skilled in the art can modify variously for the examples described in the text of the invention, without departing from the spirits and scope of the invention.

For example, it is also possible to constitute by recording on an image recording medium the processing program that is processed in the remote control system (image forming system), the image forming apparatus and the administrative apparatus, the explained processing and the whole or a part of data. Further, those wherein the aforesaid processing programs are incorporated in an electronic mail software which can be operated by an ordinary personal computer or by a portable remote terminal, or information recording media in which the incorporated electronic mail software are recorded, are included.

As an information recording medium, a semiconductor memory such as, for example, ROM, RAM and flash memory, and an integrated circuit, an optical disk, a photomagnetoelectric disk and a magnetic recording medium can be used, and it is further possible to compose and use by recording on CD-ROM, a hard disk, CD-R, CD-RW, FD, DVDRAM, DVDROM, MO, SIP, a magnetic card, a magnetic tape, a nonvolatile memory card and IC card.

Furthermore, as an example of a medium, there are given a wireless or infrared transmission channel between a computer and another device, a card which can be read by a computer, network connection to a separate computer or a device on a network, and the internet or intranet including information of electronic mail transmission or information recorded on a website and others.

When this information recording medium is used in a system other than systems in the aforesaid examples or in an apparatus, and when that system or a computer reads a program stored in this recording medium and executes, it is possible to realize the function equal to that in each example stated above and to obtain the same effect.

Further, when OS operating on the computer or RTOS on the image forming apparatus execute a part of or the whole of the processing, or even when CPU provided on an expansion function board or on an expansion function unit conducts a part or the whole of processing after a program code read out from a recording medium is written in a memory provided on the expansion function board inserted in a computer or an image forming apparatus or on the expansion function unit connected to a computer or an image forming apparatus, based on the instruction of the program code, it is possible to realize the function equal to that in each example stated above and to obtain the same effect.

To be concrete, with respect to processing in the first-eighth examples stated above, the information recording medium is one on which a program to make the image forming apparatus to access the administrative apparatus through the network and to rewrite the first program of the image forming apparatus into the second program of the administrating apparatus is recorded.

This information recording medium includes program information which makes the image forming apparatus to access the administrative apparatus to obtain the second program and conducts processing to judge the timing for the rewriting, and includes program information which conducts execution of the rewriting based on the results of the aforesaid judgment.

Further, the information recording medium includes information wherein the image forming apparatus accesses the administrative apparatus to obtain the second program during a warm-up period after turning on the power for the image forming apparatus, and the first program is rewritten into the second program.

Further, the information recording medium includes information wherein the image forming apparatus accesses the administrative apparatus to obtain the second program during a specific time band in which the image forming apparatus set in advance is unused and the first program is rewritten into the second program.

Further, the information recording medium includes information for conducting processing to set the timing for rewriting on the administrative apparatus side, information for conducting the instruction for downloading from the administrative apparatus to the image forming apparatus, and for conducting processing to urge the image forming apparatus to obtain the second program, and information for conducting processing to judge whether the second program should be rewritten into the first program or not on the administrative apparatus side.

Further, the information recording medium includes information for conducting processing to judge whether the second program should be rewritten into the first program or not on the image forming apparatus side.

Further, with respect to processing in the ninth and tenth examples stated above, the information recording medium includes information to conduct processing to judge the first program stored in the first area of the storing means in the image forming apparatus is abnormal or not, and information to conduct processing to rewrite the first program into the second program based on the minimum program stored in the second area of the storing means, when the first program is judged to be abnormal.

Further, the information recording medium includes information for conducting processing to make the image forming apparatus to operate based on the first program when the first program is judged to be normal, information for conducting processing to judge whether the rewriting is necessary or not based on the first program and information for conducting processing to rewrite the first program into the second program based on the first program, the connection program for the network, and on the program for rewriting, when the rewriting is judged to be necessary.

Further, the information recording medium includes information for conducting processing wherein initiation is started by the second storing means that stores a command of jumping to the first storing means that stores the first program, when the image forming apparatus is operating, information for conducting processing to judge whether the command for jumping is present or not, information for conducting processing to start the first program from the first storing means when the command for jumping is judged to be present, information for conducting processing to judge whether the rewriting is necessary or not, and information to conduct processing to make the second storing means to store the minimum program to connect to the network stored in the first storing means and obtains the second program to conduct rewriting when the rewriting is judged to be necessary.

Further, the information recording medium includes information for conducting processing to judge whether the rewriting for rewriting the first program to the second program was completed normally or not, and information for conducting processing to make them operate based on the program stored in the first storing means when the rewriting is judged to be abnormal.

Further, with respect to processing in the eleventh example stated above, the information recording medium includes information wherein the image forming apparatus obtains the second program through the network and processing to rewrite the first program into the second program is conducted, and information for conducting processing to output a rewriting processing termination report when the rewriting is completed.

Further, the information recording medium includes information for conducting processing to output the rewriting processing termination report onto a facsimile received image tray when the rewriting processing is terminated, information for conducting processing to facsimile-transmit the rewriting processing termination report to the designated target when the rewriting processing is terminated, and information for conducting processing to transmit the rewriting processing termination report to the designated target as an electronic mail, when the rewriting processing is terminated.

Further, the information recording medium includes information for conducting processing to output the rewriting processing termination report with the image forming means, when the rewriting processing is terminated, and rewriting confirmation communication is terminated.

Further, the information recording medium includes information for conducting processing to output the rewriting processing termination report to a facsimile received image output tray, when the rewriting processing is terminated, and the rewriting confirmation communication from the administrative apparatus side has been terminated.

Further, the information recording medium includes information for conducting processing to facsimile-transmit the rewriting processing termination report to the designated target when the rewriting processing is terminated and rewriting confirmation communication from the administrative apparatus side is terminated, and information for conducting processing to transmit the rewriting processing termination report to the designated target as an electronic mail, when the rewriting processing is terminated, and rewriting confirmation communication from the administrative apparatus side is terminated.

Further, with respect to each processing program conducting each processing, or an overall or partial processing conducted by combining some of processing, it may be shown with a functional name such as “ . . . means” in the structure.

Further, examples of a combination of the aforesaid examples stated above and of a combination of the aforesaid examples and their variations may naturally included.

As stated above, the invention makes it possible to judge the timing for rewriting automatically, to connect to the network automatically, and to access the file administrative system to conduct rewriting automatically if the rewriting is necessary.

In this case, the timing for connecting with the network and whether the automatic rewriting is to be conducted or not can be set by a user respectively. Therefore, it is possible to conduct rewriting without getting assistance from another at the time when the use of the image forming apparatus is not interrupted, such as the time during unused time zone in which the image forming apparatus is not used, or the time when warm-up is conducted after turning on powers for the image forming apparatus, thus, the image forming apparatus can be used constantly under the latest program.

Since the rewriting is conducted during a warm-up period, excessive load is not applied on the image forming apparatus, and troubles caused by the rewriting of the program can be removed in the course of rewriting processing.

Further, when the administrative apparatus administers information about an unused time zone of the image forming apparatus, it is also possible to instruct from the administrative apparatus side to conduct downloading and rewriting processing. In this case, the timing becomes more accurate when a telephone line network is used for the network through which the program is transferred.

In addition, when a sub-host is provided as an image forming system, the number of programs to be obtained through the network such as the internet has only to be one when a plurality of image forming apparatuses are present in LAN, for example, when a plurality of machines of the same type are present, and thereby, it is possible to realize reduction of time and to achieve centralized control by a user for image forming apparatuses in LAN.

Further, in the other embodiment of the invention, the necessary and minimum program to access the network and to obtain the second program from the administrative apparatus for rewriting is stored, in advance, in the unrewritable second area of a storing means of the image forming apparatus, thus, the necessary and minimum program in the second area operates to make restoration to be easy, when abnormal termination such as disconnection is caused. Due to this, even when disconnection is caused, a service engineer does not need to visit the actual spot for restoration work, which is different from the practice in the past, and it is possible to restore so that the image forming apparatus may operate automatically under the new second program after turning on the power, and thereby to shorten a period of time during which the image forming apparatus cannot be used by a user.

Another embodiment of the invention makes it possible to save time to contact a user separately, because it is possible to output a rewriting processing termination report in writing.

What is claimed is:

1. An image forming system, comprising:
an image forming apparatus, provided with a rewritable storage means for storing a first program, for operating based on said first program so as to conduct image forming on a recording medium; wherein said image forming apparatus comprises:
a) a setting means for setting a first area, where contents of said storage means is rewritable, and a second area where contents of said storage means is not rewritable;
b) an accessing means for accessing a file administrative system with a program in said second area to obtain a second program; and
c) rewriting means for rewriting said first program stored in said first area to said second program;
said file administrative system, provided with an administrative storage means for storing said second program which is an upgraded version of said first program; and
a network for connecting said image forming apparatus with said file administrative system.

2. The image forming system of claim 1, wherein said program in said second area is a minimum program for obtaining said second program by establishing a connection with said file administrative system.

3. The image forming system of claim 2, wherein said program in said second area includes a network program for establishing a connection with said network.

4. The image forming system of claim 3, wherein said network program includes a network protocol which is capable of going through a fire wall system.

5. The image forming system of claim 4, wherein said network protocol is FTP.

6. The image forming system of claim 3, wherein said program in said second area includes a minimum operating system for executing said network program.

7. The image forming system of claim 2, wherein said program in said second area includes a program for rewriting said first program to said second program.

8. An image forming system, comprising:
an image forming apparatus, provided with a rewritable first storage means for storing a first program, for operating based on said first program so as to conduct image forming on a recording medium; wherein said image forming apparatus comprises:
a) a second storage means for storing an instruction for jump to said first storage means; and
b) a control means for setting and controlling said image forming apparatus so as to be started with said second storage means when said image forming apparatus is operating;
a file administrative system, provided with an administrative storage means for storing said second program which is an upgraded version of said first program; and
a network for connecting said image forming apparatus with said file administrative system.

9. The image forming system of claim 8, wherein said control means controls said image forming apparatus so that said second storage means stores a minimum program, stored in said first storage means, to establish a connection with said network when said first program is rewritten to said second program.

10. The image forming system of claim 8, comprising:
a determination means for determining whether a rewriting operation of said first program to said second program is completed normally;
wherein said control means controls said image forming apparatus so as to operate in accordance with a program stored in said first storage means when said rewriting operation of said first program to said second program is determined to be completed abnormally.

11. The image forming system of claim 8, wherein said first storage means includes an operating system for administering operation of said image forming apparatus, an application program running on said operating system and a network program for establishing a connection with said network.

12. An image forming apparatus, provided with a rewritable storage means for storing a first program, for operating based on said first program so as to conduct image forming on a recording medium, comprising:
a setting means for setting a first area, where contents of said storage means is rewritable, and a second area where contents of said storage means is not rewritable; and
an accessing means for accessing a file administrative system with a program in said second area to obtain a second program which is an upgraded version of said first program; and
a rewriting means for rewriting said first program stored in said first area to said second program.

13. The image forming system of claim 12, wherein said program in said second area is a minimum program for obtaining said second program by establishing a connection with said file administrative system.

14. The image forming system of claim 13, wherein said program in said second area includes a network program for establishing a connection with said network.

15. The image forming system of claim 14, wherein said network program includes a network protocol which is capable of going through a fire wall system.

16. The image forming system of claim 15, wherein said network protocol is FTP.

17. The image forming system of claim 14, wherein said program in said second area includes a minimum operating system for executing said network program.

18. The image forming system of claim 12, wherein said program in said second area includes a program for rewriting said first program to said second program.

19. An image forming apparatus, provided with a rewritable first storage means for storing a first program, for operating based on said first program so as to conduct image forming on a recording medium, comprising:
a second storage means for storing an instruction for jump to said first storage means; and
a control means for setting and controlling said image forming apparatus so as to be started with said second storage means when said image forming apparatus is operating.

20. The image forming system of claim 19, wherein said control means controls said image forming apparatus so that said second storage means stores a minimum program, stored in said first storage means, to establish a connection with said network when said first program is rewritten to said second program by accessing said network.

21. The image forming system of claim 20, comprising:
a determination means for determining whether a rewriting operation of said first program to said second program is completed normally;
wherein said control means controls said image forming apparatus so as to operate in accordance with a program stored in said first storage means when said rewriting operation of said first program to said second program is determined to be completed abnormally.

22. A program rewriting method for rewriting a first program of an image forming apparatus, which forms an image on a recording medium in accordance with said first program, to a second program with an administrative apparatus which is capable of communicating with said image forming apparatus through a network; comprising the steps of:
deciding whether said first program stored in a first area in a storage means of said image forming apparatus is abnormal or not; and
rewriting said first program to said second program based on a minimum program stored in a second area of said storage means when said first program is decided to be abnormal.

23. The program rewriting method of claim 22, comprising the steps of:
actuating said image forming apparatus in accordance with said first program when said first program is decided to be normal;
deciding whether said first program is necessary to be rewritten or not;
rewriting said first program to said second program in accordance with a connecting program for establishing a connection with said network and a rewriting program when said first program is decided necessary to be rewritten.

24. A program rewriting method for rewriting a first program of an image forming apparatus, which forms an image on a recording medium in accordance with said first program, to a second program with an administrative apparatus which is capable of communicating with said image forming apparatus through a network; comprising the steps of:
starting up said image forming apparatus with said second storage means which stores an instruction for jump to said first storage means storing said first program when said image forming apparatus is operating.

25. The program rewriting method of claim 24, comprising the steps of:
deciding whether said instruction for jump exists or not;
executing said first program in said first storage means when said instruction for jump is determined to exist;
deciding whether rewriting operation of said first program is necessary or not;
storing a minimum program, stored in said first storage means for obtaining said second program by connecting to said network and for rewriting said first program to said second program, into said second storage means when said first program is decided necessary to be rewritten.

26. The program rewriting method of claim 24, comprising the steps of:
determining whether a rewriting operation of said first program to said second program is completed normally or not;
actuating said image forming apparatus in accordance with said first program in said first storage means when said rewriting operation is determined completed abnormally.

27. A recording medium with a program recorded therein, wherein said program is for rewriting a first program of an image forming apparatus, which forms an image on a recording medium in accordance with said first program, to a second program with an administrative apparatus which is capable of communicating with said image forming apparatus through a network, and said program comprises the steps of:
deciding whether said first program stored in a first area of a storage means of said image forming apparatus is abnormal or not; and
rewriting said first program to said second program based on a minimum program stored in a second area of said storage means when said first program is decided to be abnormal.

28. A recording medium with a program recorded therein, wherein said program is for rewriting a first program of an image forming apparatus, which forms an image on a recording medium in accordance with said first program, to a second program with an administrative apparatus which is capable of communicating with said image forming apparatus through a network, and said program comprises the steps of:
starting up said image forming apparatus with said second storage means which stores an instruction for jump to said first storage means storing said first program when said image forming apparatus is operating.

29. An image forming system, comprising:
an image forming apparatus, provided with a rewritable storage means for storing a first program, for operating based on said first program so as to conduct image forming on a recording medium; wherein said image forming apparatus comprises:
a) an accessing means for accessing a file administrative system so as to obtain a second program;
b) a decision means for deciding timing for rewriting said first program to said second program; and
c) a control means for controlling implementation of rewriting in accordance with said timing;
said file administrative system, provided with an administrative storage means for storing said second program which is an upgraded version of said first program; and
a network for connecting said image forming apparatus with said file administrative system.

30. The image forming system of claim 29, wherein said image forming apparatus comprises a first connection starting means for starting a connection to said file administrative system during a warm-up process after turn on of said image forming apparatus.

31. The image forming system of claim 30, wherein said control means controls said image forming apparatus so as to obtain said second program and to rewrite said first program to said second program during said warm-up process when said decision means decides that a rewriting operation of said first program to said second program is necessary.

32. The image forming system of claim 29, wherein said image forming apparatus comprises a second connection starting means for starting a connection to said file administrative system during a predetermined specific time zone when said image forming apparatus is not in use.

33. The image forming system of claim 32, wherein said control means controls said image forming apparatus so as to obtain said second program and to rewrite said first program to said second program during said predetermined specific time zone when said decision means decides that a rewriting operation of said first program to said second program is necessary; and said control means controls said image forming apparatus so as to operate in accordance with said second program.

34. The image forming system of claim 29, wherein said image forming apparatus comprises a display operation means for displaying a setting screen to set timing of a rewriting operation wherein said control means controls said image forming apparatus so as to perform said rewriting operation in accordance with said timing which is set with said setting screen.

35. The image forming system of claim 29, wherein said file administrative system comprises a setting means for setting timing of a rewriting operation of said first program to said second program.

36. The image forming system of claim 29, wherein said file administrative system comprises a necessity decision means for deciding whether it is necessary or not to perform a rewriting operation in accordance with version data of said first program in said rewritable storage means and of said second program in said administrative storage means.

37. The image forming system of claim 29, wherein each of said first program and said second program corresponds to a piece of information regarding program creation date, program stored date, program version, rewriting history and corresponding image forming apparatus type; and said second program decides to perform a rewriting operation of said first program, in said rewritable storage means, in accordance with said piece of information.

38. The image forming system of claim 29, wherein said administrative storage means stores a plurality of programs corresponding said second program.

39. An image forming system, comprising:
an image forming apparatus, provided with a rewritable storage means for storing a first program, for operating based on said first program so as to conduct image forming on a recording medium; wherein said image forming apparatus comprises:
a) an accessing means for accessing said program based on an instruction of downloading, transmitted from a file administrative system, so as to obtain a second program;
b) a decision means for conducting a decision whether said first program can be rewritten to said second program or not; and
c) a control means for controlling implementation of rewriting in accordance with said decision by said decision means;
said file administrative system, provided with an administrative storage means for storing said second program which is an upgraded version of said first program wherein said file administrative system includes a setting means for setting rewriting timing of said first program to said second program; and
a network for connecting said image forming apparatus with said file administrative system.

40. The image forming system of claim 39, wherein said file administrative system comprises a necessity decision means for deciding whether it is necessary or not for said second program to perform a rewriting operation of said first program, stored in said rewritable storage means, in accordance with version data of said first program in said rewritable storage means and of said second program in said administrative storage means.

41. The image forming system of claim 39, wherein said image forming apparatus comprises a necessity decision means for deciding whether it is necessary or not for said second program to perform a rewriting operation of said first program, stored in said rewritable storage means, in accordance with version data of said first program in said rewritable storage means and of said second program in said administrative storage means.

42. The image forming system of claim 39, wherein each of said first program and said second program corresponds to a piece of information regarding program creation date, program stored date, program version, rewriting history and corresponding image forming apparatus type; and said second program decides to perform a rewriting operation of said first program, in said rewritable storage means, in accordance with said piece of information.

43. The image forming system of claim 40, wherein said administrative storage means stores a plurality of programs corresponding said second program.

44. The image forming system of claim 39, wherein said network includes a first network for transmitting said second program and a second network for transmitting said instruction of downloading.

45. The image forming system of claim 44, wherein said first network is the internet and said second network is a public telephone line.

46. An image forming system, comprising:
an image forming apparatus, provided with a rewritable first storage means storing a first program, for operating based on said first program so as to conduct image forming on a recording medium; wherein said image forming apparatus comprises:
a) an accessing means for accessing a second storage means through a user network so as to obtain said second program;
b) a decision means for deciding timing for rewriting said first program to said second program; and
c) a control means for controlling implementation of rewriting in accordance with said timing;
a program administrative system, provided with an administrative storage means for storing said second program which is an upgraded version of said first program;
a general network for connecting said user network with said program administrative system;
a sub-host provided with a second storage means for obtaining said second program, stored in said administrative storage means, by accessing said program administrative system through said general network and stores said second program; and
said user network for connecting said image forming apparatus with said sub-host.

47. The image forming system of claim 46, wherein said image forming apparatus includes a first connection starting means for starting a connection to said sub-host during warm-up process after turn on of said image forming apparatus.

48. The image forming system of claim 47, wherein said control means controls said image forming apparatus so as to obtain said second program and to rewrite said first program to said second program during said warm-up process when said decision means decides that a rewriting operation of said first program to said second program is necessary.

49. The image forming system of claim 46, wherein said image forming apparatus comprises a second connection starting means for starting a connection to said sub-host during a predetermined specific time zone when said image forming apparatus is not in use.

50. The image forming system of claim 49, wherein said control means controls said image forming apparatus so as to obtain said second program and to rewrite said first program to said second program during said predetermined specific time zone when said decision means decides that a rewriting operation of said first program to said second program is necessary; and said control means controls said image forming apparatus so as to operate in accordance with said second program.

51. The image forming system of claim 47, wherein said image forming apparatus comprises a display operation means for displaying a setting screen to set timing of a rewriting operation wherein said control means controls said image forming apparatus so as to perform said rewriting operation in accordance with said timing which is set with said setting screen.

52. The image forming system of claim 47, wherein said sub-host comprises a setting means for setting timing of a rewriting operation of said first program to said second program.

53. The image forming system of claim 46, wherein said sub-host comprises a necessity decision means for deciding whether it is necessary or not to perform a rewriting operation in accordance with version data of said first program in said first storage means and of said second program in said second storage means.

54. The image forming system of claim 46, wherein each of said first program and said second program corresponds to a piece of information regarding program creation date, program stored date, program version, rewriting history and corresponding image forming apparatus type; and said second program decides to perform a rewriting operation of said first program, in said first storage means, in accordance with said piece of information.

55. The image forming system of claim 46, wherein said second storage means stores a plurality of programs corresponding said second program.

56. The image forming system of claim 46, wherein said sub-host comprises a necessity decision means for deciding whether it is necessary or not for said second program, stored in said second storage means, to perform a rewriting operation of said first program, stored in said first storage means.

57. The image forming system of claim 47, wherein said sub-host obtains said second program, which is for being transmitted to each of a plurality of image forming apparatuses connected to said user network, from said administrative storage means.

58. The image forming system of claim 47, wherein said sub-host establishes a connection to said program administrative system so as to obtain said second program, stored in said administrative storage means, in accordance with an instruction of downloading, transmitted from said program administrative system.

59. The image forming system of claim 46, wherein said image forming apparatus obtains said second program, stored in said second storage means, and rewrites said first program, stored in said first storage means, to said second program in accordance with an instruction of downloading, transmitted from said sub-host.

60. An image forming apparatus for conducting image forming on a recording medium in accordance with a first program, comprising:
a rewritable storage means for storing said first program;
an acquiring means for acquiring a second program through a network, connected with said image forming apparatus;
a decision means for deciding timing for rewriting said first program to said second program;
a first connection starting means for starting a connection to said network for acquisition during warm-up process after turn on of said image forming apparatus; and
a control means for starting connection by said first connection starting means in accordance with said timing, and for controlling implementation of rewriting.

61. An image forming apparatus for conducting image forming on a recording medium in accordance with a first program, comprising:
a rewritable storage means for storing said first program;
an acquiring means for acquiring a second program through a network, connected with said image forming apparatus;
a decision means for deciding timing for rewriting said first program to said second program;
a second connection starting means for starting a connection to said network for acquisition in a predetermined specific time zone when said image forming apparatus is not in use; and
a control means starting connection by said second connection starting means in accordance with said timing, and for controlling implementation of rewriting.

62. An administrative apparatus, connected with an image forming apparatus for forming an image on a recording medium through said network, for administering said image forming apparatus for rewriting a first program of said image forming apparatus to a second program, comprising:
a transmission means for transmitting said second program to said image forming apparatus;
a setting means for setting timing for rewriting said first program to said second program; and
a control means for conducting an instruction for downloading to said image forming apparatus through said transmission means at said timing so that said image forming apparatus is urged to obtain said second program.

63. The administrative apparatus of claim 62, comprising a decision means for deciding whether it is necessary or not to perform a rewriting operation of said first program to said second program in accordance with version data of said first program and of said second program.

64. A program rewriting method for rewriting a first program of an image forming apparatus, which forms an image on a recording medium in accordance with said first program, to a second program with an administrative apparatus which is capable of communicating with said image forming apparatus through a network; comprising the steps of:
controlling said image forming apparatus to access to said administrative apparatus during warm-up process after turn on of said image forming apparatus so as to obtain said second program; and
controlling said image forming apparatus to rewrite said first program to said second program.

65. A program rewriting method for rewriting a first program of an image forming apparatus, which forms an image on a recording medium in accordance with said first program, to a second program with an administrative apparatus which is capable of communicating with said image forming apparatus through a network; comprising the steps of:
controlling said image forming apparatus to access said administrative apparatus in a predetermined specific time zone, when said image forming apparatus is not in use, so as to obtain said second program; and
controlling said image forming apparatus to rewrite said first program to said second program.

66. A program rewriting method for rewriting a first program of an image forming apparatus, which forms an image on a recording medium in accordance with said first program, to a second program with an administrative apparatus which is capable of communicating with said image forming apparatus through a network; comprising the steps of:
controlling said administrative apparatus to setting a timing for rewriting;
controlling said administrative apparatus to conduct an instruction for downloading to said image forming apparatus at a predetermined timing; and
controlling said image forming apparatus to obtain said second program.

67. The program rewriting method of claim 66, comprising the step of deciding with said administrative apparatus whether it is necessary or not to perform a rewriting operation of said first program to said second program.

68. The program rewriting method of claim 66, comprising the step of deciding with said image forming apparatus whether it is necessary or not to perform a rewriting operation of said first program to said second program.

69. The program rewriting method of claim 67, wherein said step of deciding is performed in accordance with version data of said first program and of said second program.

70. A recording medium with a program recorded therein, wherein said program is for rewriting a first program of an image forming apparatus, which forms an image on a recording medium in accordance with said first program, to a second program with an administrative apparatus which is capable of communicating with said image forming apparatus through a network, and said program comprises the steps of:
controlling said image forming apparatus to access to said administrative apparatus during warm-up process after turn on of said image forming apparatus so as to obtain said second program; and
controlling said image forming apparatus to rewrite said first program to said second program.

71. A recording medium with a program recorded therein, wherein said program is for rewriting a first program of an image forming apparatus, which forms an image on a recording medium in accordance with said first program, to a second program with an administrative apparatus which is capable of communicating with said image forming apparatus through a network, and said program comprises the steps of:
controlling said image forming apparatus to access said administrative apparatus in a predetermined specific time zone, when said image forming apparatus is not in use, so as to obtain said second program; and
controlling said image forming apparatus to rewrite said first program to said second program.

72. A recording medium with a program recorded therein, wherein said program is for rewriting a first program of an image forming apparatus, which forms an image on a recording medium in accordance with said first program, to a second program with an administrative apparatus which is capable of communicating with said image forming apparatus through a network, and said program comprises the steps of:
controlling said administrative apparatus to setting a timing for rewriting;
controlling said administrative apparatus to conduct an instruction for downloading to said image forming apparatus at a predetermined timing; and
controlling said image forming apparatus to obtain said second program.

73. An image forming system, comprising:
an image forming apparatus, provided with a rewritable storage means for storing a first program, for operating based on said first program so as to conduct image forming on a recording medium; wherein said image forming apparatus comprises:
a) an acquiring means for acquiring a second program through a network;
b) a rewriting means for conducting a rewriting operation of said first program to said second program; and
C) a control means for controlling said image forming apparatus to output a report of completion of said rewriting operation when said rewriting operation by said rewriting means is completed;
said file administrative system, provided with an administrative storage means for storing said second program which is an upgraded version of said first program; and
a network for connecting said image forming apparatus with said file administrative system.

74. The image forming system of claim 73, wherein said control means controls said image forming apparatus to output said report to an image receipt tray of a facsimile means.

75. The image forming system of claim 73, wherein said control means controls said image forming apparatus to send said report as a facsimile to a predetermined destination.

76. The image forming system of claim 73, wherein said control means controls said image forming apparatus to send said report as an E-mail to a predetermined destination.

77. The image forming system of claim 73, wherein wherein said control means controls said image forming apparatus to output said report when said rewriting operation is completed and a rewriting completion confirmation is transmitted from said file administrative system.

78. The image forming system of claim 73, wherein wherein said control means controls said image forming apparatus to output said report to an image receipt tray of a facsimile means when said rewriting operation is completed and a rewriting completion confirmation is transmitted from said file administrative system.

79. The image forming system of claim 73, wherein wherein said control means controls said image forming apparatus to send said report as a facsimile to a predetermined destination when said rewriting operation is completed and a rewriting completion confirmation is transmitted from said file administrative system.

80. The image forming system of claim 73, wherein wherein said control means controls said image forming apparatus to send said report as an E-mail to a predetermined destination when said rewriting operation is completed and a rewriting completion confirmation is transmitted from said file administrative system.

81. An image forming apparatus for forming an image on a recording medium based on a first program, comprising:
a communication means for communicating with an administrative apparatus through a network so as to rewriting said first program to said second program which is an upgraded version of said first program;
a facsimile means for forming an image in facsimile procedures;
a printing means for conducting image forming in accordance with data sent from an outside information processing apparatus;
a document reading means for reading a document so as to obtain image information;
an image forming means for conducting image forming based on said image information from said document reading means;
a mode changing means for changing an operation mode of said image forming apparatus with among said facsimile means, said printing means and said image forming means;
a rewriting means for conducting a rewriting operation of said first program to said second program; and
a control means for controlling said image forming apparatus to output a report of completion of said rewriting operation when said rewriting processing by said rewriting means is completed.

82. The image forming system of claim 81, wherein said control means controls said image forming apparatus to output said report to an image receipt tray of a facsimile means.

83. The image forming system of claim 81, wherein said control means controls said image forming apparatus to send said report as a facsimile to a predetermined destination.

84. The image forming system of claim 81, wherein said control means controls said image forming apparatus to send said report as an E-mail to a predetermined destination.

85. The image forming system of claim 81, wherein wherein said control means controls said image forming apparatus to output said report when said rewriting operation is completed and a rewriting completion confirmation is transmitted from said file administrative system.

86. The image forming system of claim 81, wherein wherein said control means controls said image forming apparatus to output said report to an image receipt tray of a facsimile means when said rewriting operation is completed and a rewriting completion confirmation is transmitted from said file administrative system.

87. The image forming system of claim 81, wherein wherein said control means controls said image forming apparatus to send said report as a facsimile to a predetermined destination when said rewriting operation is completed and a rewriting completion confirmation is transmitted from said file administrative system.

88. The image forming system of claim 81, wherein wherein said control means controls said image forming apparatus to send said report as an E-mail to a predetermined destination when said rewriting operation is completed and a rewriting completion confirmation is transmitted from said file administrative system.
